(19) United States
(12) Patent Application Publication
(10) Pub. No.: US 2008/0269446 A1
(43) Pub. Date: Oct. 30, 2008

(54) Method for Producing Carboxylate-Rich Copolymers from Monoethylenically Unsaturated Monocarboxylic and Dicarboxylic Acids and Carboxylate-Rich Copolymers Having a Low Neurtralization Degree

(75) Inventors: Kathrin Michl, Ludwigshafen (DE); Matthias Gerst, Neustadt (DE); Frank Klippel, Ludwigshafen (DE); Alexander Gothlich, Mannheim (DE); Frank Dietsche, Schriesheim (DE); Helmut Witteler, Wachenheim (DE); Dieter Faul, Niederkirchen (DE)

Correspondence Address: CONNOLLY BOVE LODGE & HUTZ, LLP, P O BOX 2207, WILMINGTON, DE, 19899, US

(73) Assignee: Basf Aktiengesellschaft, Ludwigshafen (DE)

(21) Appl. No.: 11/661,002

(22) PCT Filed: Aug. 4, 2005
(86) PCT No.: PCT/EP2005/008444

§ 371 Date: Feb. 23, 2007

(30) Foreign Application Priority Data
Aug. 24, 2004 (DE) 102004041127.1

(51) Int. Cl. C08F 22/02; C08F 2/00

(52) U.S. Cl. 526/211; 526/318.2; 526/236

(57) ABSTRACT

Partially neutralized carboxylate-rich copolymers, processes for their preparation and methods of using the same are disclosed, the copolymers comprising: monomers (A), (B), and (C); wherein monomer (A) comprises at least one monoethylenically unsaturated monocarboxylic acid, and is present in an amount of 30% to 79.99% by weight; wherein monomer (B) comprises at least one monoethylenically unsaturated dicarboxylic acid selected from the group consisting of acids corresponding to general formula I, acids corresponding to general formula II, anhydrides thereof, and other hydrolyzable derivatives thereof, and is present in an amount of 20.01% to 70% by weight:

(HOOC)R1C═CR2(COOH) (I)

R1R2C═C(—(CH2)n-COOH)(COOH) (II)

wherein R1 and R2 each independently represent H or a straight-chain or branched, optionally substituted alkyl radical having 1 to 20 carbon atoms, or, in the case of (I), R1 and R2 together being an optionally substituted alkylene radical having 3 to 20 carbon atoms, and n represents an integer from 0 to 5; wherein monomer (C) comprises at least one additional ethylenically unsaturated comonomer, and is present in an amount of 0% to 40% by weight; wherein the carboxylate-rich copolymer is partially neutralized with at least one amine and the carboxylate-rich copolymer has a degree of neutralization of 2 to 18 mol %, based on the total amount of all COOH groups of the monocarboxylic and dicarboxylic acids; and wherein the carboxylate-rich copolymer has an average molecular weight Mw of at least 3000 g/mol.

The present invention relates to the preparation of carboxylate-rich copolymers from monoethylenically unsaturated monocarboxylic and dicarboxylic acids having an average molecular weight M_{w} of at least 3000 g/mol and also at least 20.01% by weight of the dicarboxylic acid by free-radical polymerization in the presence of 2 to 19.9 mole equivalents of an organic amine, based on the total amount of all COOH groups of the monocarboxylic and dicarboxylic acids, at a temperature of not more than 130° C. The invention further relates to carboxylate-rich copolymers having a low degree of neutralization, which are obtainable by the process, and to the use of such copolymers for treating surfaces and also as binders for fiber binding.

Copolymers of monoethylenically unsaturated monocarboxylic and dicarboxylic acids such as, for example, acrylic acid-maleic acid copolymers and also preparation processes for such copolymers are known in principle. By way of example reference may be made to EP-A 075 820, EP-A 106 110, EP-A 451 508, DE-A 40 04 953, EP-A 279 892, EP-A 398 724, EP-A 942 015 or WO 99/26988. Copolymers of this kind have a greater COOH density than polyacrylic acids and are used for a wide variety of end applications: for example, as incrustation inhibitors, as constituents of detergents and cleaning compositions, or as absorbers for liquids.

The use of such copolymers as constituents of compositions for metal surface treating methods is disclosed in the as yet unpublished application PCT/EP/04/001590.

In addition it is possible to use such polymers as components of binders for fiber binding: for example, for binding nonwovens. This is disclosed, for example, in WO 97/31059. In this application the polymers are usually mixed with a suitable crosslinker and the nonwoven is treated with the formulation and cured. Crosslinkers which can be used are preferably polyalcohols, which on heating react with the COOH groups of the polymer, with esterification.

Monoethylenically unsaturated dicarboxylic acids are usually much slower to react in the course of the free-radical polymerization than monocarboxylic acids such as (meth)acrylic acid, for example. This is true even of dicarboxylic acids such as itaconic acid or methylenemalonic acid. Particularly slow to react are maleic acid, fumaric acid and similar dicarboxylic acids in which the carboxyl groups are located on both sides of the double bond. Copolymers of monoethylenically unsaturated monocarboxylic and dicarboxylic acids therefore frequently comprise greater or lesser fractions of uncopolymerized dicarboxylic acids.

High residual amounts of dicarboxylic acids are unwanted for many applications. When the polymers are used for fiber binding, these residual amounts lead to poorer mechanical strengths of the bound products. When they are used for metal surface treatment, an unwanted gray haze is a frequent result. Additionally, free residual dicarboxylic acid can be leached out again.

It is possible in theory to clean the polymers following their preparation. However, to do so is inconvenient and uneconomic.

The total or partial neutralization of the COOH groups of the monomers used with bases in the course of the polymerization is known. By this means it is possible to lower the fraction of uncopolymerized dicarboxylic acid.

EP-A 075 820 discloses a process for preparing copolymers from 40 to 90% by weight of monoethylenically unsaturated monocarboxylic acids and 10 to 60% by weight of monoethylenically unsaturated dicarboxylic acids. The polymerization is conducted in aqueous solution at 60 to 150° C. and the COOH groups on the monomers are neutralized to the extent of 20 to 80%, using NaOH, KOH, NH₃ or organic amines, for example. The examples describe the use of sodium hydroxide solution. At a degree of neutralization of less than 20% there is a marked increase in the residual dicarboxylic acid content, and also at a degree of neutralization of more than 80%. Only within the window described are residual dicarboxylic acid contents of less than 1.5% by weight obtained.

EP-A 106 110 and EP-A 398 724 disclose a similar process, in which the degree of neutralization is likewise 20 to 80%.

EP-A 451 508 discloses a process for preparing copolymers from ethylenically unsaturated dicarboxylic acids and various ethylenically unsaturated monocarboxylic acids, in which the degree of neutralization used is from 52% to 70%.

WO 99/26988 discloses a two-stage process for preparing polymers from acrylic acid and acrylic acid derivatives, particularly acrylamides, in which in a first stage the polymerization is performed and in a second stage the residual monomer content is lowered by afterreaction at 120 to 240° C., preferably 140 to 180° C. The degree of neutralization of the monomers is 10% to 100%. Bases proposed are NH₃ and organic amines. Acrylic acid-maleic acid copolymers are not disclosed.

EP-A 942 015 discloses a polymer composition which comprises a (meth)acrylic acid-maleic acid copolymer. The copolymer possesses the capacity to disperse clay. The examples describe the preparation of a copolymer having a maleic acid content of 15.2% by weight in the presence of NaOH as base and with degrees of neutralization of 12.5%, 25% and 50%. After the preparation the (co)polymer is completely neutralized.

The techniques outlined, with a greater or lesser degree of neutralization, lead to copolymers which in turn are wholly or at least partly neutralized. Many applications, however, require polymers having a very high fraction of unneutralized COOH groups. In order to obtain a very high COOH group density, moreover, a very high dicarboxylic acid fraction is desired.

The prior art cited above, however, shows that when the degree of neutralization retreats to below 20% the fraction of unpolymerized dicarboxylic acid in the product goes up. Naturally the problem of the residual fraction of unpolymerized dicarboxylic acid in the polymer is greater the higher the fraction of dicarboxylic acid employed.

In principle it is possible to improve the copolymerization of the dicarboxylic acid, and to reduce the residual fractions of unpolymerized dicarboxylic acid, by raising the polymerization temperature. This is shown, for example, in EP-A 075 820 in examples 1 and 7. The examples also show, however, that the increase in temperature is accompanied by a very marked reduction in the molecular weight of the copolymer.

It was an object of the invention to provide a process for preparing copolymers from ethylenically unsaturated monocarboxylic acids and slow-to-react ethylenically unsaturated dicarboxylic acids which comprise more than 20% by weight of the dicarboxylic acid but in spite of this exhibit a low degree of neutralization of less than 20% and a low residual monomeric dicarboxylic acid content and also, in addition, an average molecular weight M_{w} of at least 3000 g/mol.

Provided accordingly has been a process for preparing carboxylate-rich copolymers from monoethylenically unsaturated monocarboxylic and dicarboxylic acids having an average molecular weight M_{w} of at least 3000 g/mol by free-radical polymerization in aqueous solution of the following monomers:
(A) 30% to 79.99% by weight of at least one ethylenically unsaturated monocarboxylic acid,
(B) 20.01% to 70% by weight of at least one ethylenically unsaturated dicarboxylic acid of the general formula

(HOOC)R¹C═CR²(COOH) (I),

and/or

R¹R²C═C(—(CH₂)ₙ—COOH)(COOH) (II),
or of the corresponding anhydrides and/or other hydrolyzable derivatives, R¹ and R² independently of one another being H or a straight-chain or branched, optionally substituted alkyl radical having 1 to 20 carbon atoms, or, in the case of (I), R¹ and R² together being an optionally substituted alkylene radical having 3 to 20 carbon atoms, and n being an integer from 0 to 5,
and
(C) 0% to 40% by weight of at least one further ethylenically unsaturated comonomer, different from (A) and (B),
   the amounts being based in each case on the total amount of all monomers employed,
      wherein the polymerization is performed in the presence of 2 to 19.9 mol % of at least one amine, based on the total amount of all COOH groups of the monocarboxylic and dicarboxylic acids, at a temperature of less than 130° C.

In a second aspect of the invention carboxylate-rich copolymers have been provided which have an average molecular weight M_{w} of at least 3000 g/mol and comprise as monomer units
(A) 30% to 79.99% by weight of monoethylenically unsaturated monocarboxylic acids,
(B) 20.01% to 70% by weight of monoethylenically unsaturated dicarboxylic acids of the general formula

(HOOC)R¹C═CR²(COOH) (I)

and/or

R¹R²C═C(—(CH₂)ₙ—COOH)(COOH) (II),
R¹ and R² independently of one another being H or a straight-chain or branched, optionally substituted alkyl radical having 1 to 20 carbon atoms, or, in the case of (I), R¹ and R² together being an optionally substituted alkylene radical having 3 to 20 carbon atoms, and n being an integer from 0 to 5,
and
(C) 0% to 40% by weight of further, ethylenically unsaturated comonomers,
   obtainable by means of the process outlined.

A third aspect of the invention provides for the use of such copolymers for treating surfaces. They are particularly suitable for treating metallic surfaces, especially for passivating metals and in particular for passivating zinc, aluminum, and galvanized and aluminized surfaces.

The copolymers of the invention are further suitable as binders for fibrous or granular substrates.

Surprisingly it has been found that through the use of the described amounts of amines as base copolymers are obtainable which exhibit a low degree of neutralization but nevertheless exhibit a likewise low residual fraction of unpolymerized dicarboxylic acid. This was also surprising on account of the fact that the use of ammonia produces no advantageous results. Copolymers can be obtained which have a very high fraction of copolymerized dicarboxylic acids but nevertheless have a comparatively high molecular weight.

The polymers of the invention exhibit distinctly improved performance properties.

In the context of the metal passivating utility a much better corrosion control can be achieved than when using copolymers having a higher degree of neutralization which have been prepared using other bases. In the context of the binder utility for fibrous or granular substrates a higher binding force is obtained and a reduced leaching loss achieved.

Details of the invention now follow.

For the process of the invention monomers (A) and (B) are used. Optionally it is also possible to use monomers (C), different from (A) and (B).

Monomer (A) is at least one monoethylenically unsaturated monocarboxylic acid. It is of course also possible to use mixtures of two or more different ethylenically unsaturated monocarboxylic acids.

Examples of suitable monoethylenically unsaturated monocarboxylic acids (A) comprise acrylic acid, methacrylic acid, crotonic acid, vinylacetic acid or else C₁-C₄ monoesters of monoethylenically unsaturated dicarboxylic acids. Preferred monomers are acrylic acid and methacrylic acid, acrylic acid being particularly preferred.

30% to 79.99% by weight of the monomer (A) is used, in particular 30 to 79.9% by weight, the amount being based on the total amount of all monomers employed for the process. It is preferred to use 40% to 78% by weight of the monomer (A), more preferably 45% to 77% by weight and very preferably 55% to 76% by weight.

Monomer (B) is at least one monoethylenically unsaturated dicarboxylic acid of the general formula (HOOC)R¹C═CR²(COOH) (I) and/or R¹R²C═C(—(CH₂)ₙ—COOH)(COOH) (II).

It is also possible to use mixtures of two or more different monomers (B). In the case of (I) the monomer in question may in each case be the cis form and/or the trans form. The monomers can also be used in the form of the corresponding carboxylic anhydrides or other hydrolyzable carboxylic acid derivatives. Where the COOH groups are located in cis form it is possible with particular advantage to use cyclic anhydrides.

R¹ and R² independently of one another are H or a straight-chain or branched, optionally substituted alkyl radical having 1 to 20 carbon atoms. Preferably the alkyl radical has 1 to 4 carbon atoms. More preferably R¹ and/or R² are/is H and/or a methyl group. The alkyl radical may also optionally contain further substituents, provided they have no adverse effect on the performance properties of the polymer or of the process.

In the case of the formula (I) a further possibility is for R¹ and R² together to be an alkylene radical having 3 to 20 carbon atoms which may also optionally be substituted further. Preferably the ring formed from the double bond and the alkylene radical comprises 5 or 6 carbon atoms. Examples of alkylene radicals comprise in particular a 1,3-propylene or a 1,4-butylene radical, which may also contain further alkyl group substituents. n is an integer from 0 to 5, preferably 0 to 3 and very preferably 0 or 1.

Examples of suitable monomers (B) of the formula (I) comprise maleic acid, fumaric acid, methylfumaric acid, methylmaleic acid, dimethylmaleic acid and also if appropriate the corresponding cyclic anhydrides. Examples of formula (II) comprise methylenemalonic acid and itaconic acid. Preference is given to using monomers of the formula (I), particular preference being given to maleic acid and maleic anhydride.

20.01% to 70% by weight of the monomers (B) is used, in particular 20.1 to 70% by weight, the amount being based on the total amount of all monomers used for the process. Preference is given to using 22% to 60% by weight of the monomer (B), more preferably 23% to 55% by weight and very preferably 25% to 45% by weight.

Besides the monomers (A) and (B) it is optionally possible to use one or more ethylenically unsaturated monomers (C) as well. Other than these no further monomers are used.

The monomers (C) serve to fine-tune the properties of the copolymer. Of course two or more different monomers (C) can also be used. They are selected by the skilled worker in accordance with the desired properties of the copolymer. The monomers (C) are likewise free-radically polymerizable.

Preferably they are likewise monoethylenically unsaturated monomers. In particular cases, however, small amounts of monomers having two or more polymerizable groups can also be used. This allows the copolymer to be crosslinked to a small extent.

The monomers (C) can be acidic and/or basic and/or neutral monomers. Preferably they are neutral monomers and/or acidic monomers.

Examples of suitable monomers (C) comprise in particular monomers which contain phosphoric acid and/or phosphonic acid groups. Mention may be made here in particular of vinylphosphonic acid, monovinyl phosphate, allylphosphonic acid, monoallyl phosphate, 3-butenylphosphonic acid, mono-3-butenyl phosphate, mono(4-vinyloxybutyl) phosphate, phosphonoxyethyl acrylate, phosphonoxyethyl methacrylate, mono(2-hydroxy-3-vinyloxypropyl) phosphate, mono(1-phosphonoxy-methyl-2-vinyloxyethyl) phosphate, mono(3-allyloxy-2-hydroxypropyl) phosphate, mono-2-(allylox-1-phosphonoxymethylethyl) phosphate, 2-hydroxy-4-vinyloxymethyl-1,3,2-dioxaphosphole and 2-hydroxy-4-allyloxymethyl-1,3,2-dioxaphosphole. It is also possible to use salts and/or esters, especially C₁ to C₈ monoalkyl, dialkyl and also, if appropriate, trialkyl esters of phosphoric acid and/or monomers containing phosphonic acid groups.

Suitability is further possessed by monomers containing sulfonic acid groups, such as allylsulfonic acid, methallylsulfonic acid, styrenesulfonate, vinylsulfonic acid, allyloxybenzenesulfonic acid, 2-acrylamido-2-methylpropanesulfonic acid or 2-(methacryloyl)ethylsulfonic acid and/or the salts and/or esters thereof, for example.

Further acidic monomers comprise, for example, maleic acid monoamides.

Examples of substantially neutral monomers (C) comprise C₁ to C₁₈ alkyl esters or C₁ to C₄ hydroxyalkyl esters of (meth)acrylic acid, such as methyl (meth)acrylate, ethyl (meth)acrylate, propyl (meth)acrylate, isopropyl (meth)acrylate, butyl (meth)acrylate, hexyl (meth)acrylate, 2-ethylhexyl (meth)acrylate, hydroxyethyl (meth)acrylate, hydroxypropyl (meth)acrylate or butane-1,4-diol monoacrylate, (methyl)styrene, maleimide or an N-alkylmaleimide.

Suitability is further possessed by vinyl or allyl ethers such as, for example, methyl vinyl ether, ethyl vinyl ether, propyl vinyl ether, isobutyl vinyl ether, 2-ethylhexyl vinyl ether, cyclohexyl vinyl ether, 4-hydroxybutyl vinyl ether, decyl vinyl ether, dodecyl vinyl ether, octadecyl vinyl ether, 2-(diethylamino)ethyl vinyl ether, 2-(di-n-butylamino)ethyl vinyl ether or methyl diglycol vinyl ether, and the corresponding allyl compounds. It is likewise possible to use vinyl esters such as, for example, vinyl acetate or vinyl propionate.

Examples of basic monomers comprise acrylamides and alkyl-substituted acrylamides, such as acrylamide, methacrylamide, N-tert-butylacrylamide or N-methyl(meth)acrylamide.

It is also possible to use alkoxylated monomers, especially ethoxylated monomers. Of particular suitability are alkoxylated monomers which derive from acrylic acid or methacrylic acid and have the general formula (III)

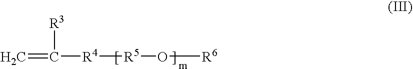

in which the variables have the following meaning:
R³ is hydrogen or methyl;
R⁴ is —(CH₂)ₓ—O—, —CH₂—NR⁷—, —CH₂—O—CH₂—CR⁸R⁹—CH₂—O— or —CONH—; COO-(ester)
R⁵ are identical or different C₂-C₄ alkylene radicals, which may be arranged in blocks or randomly, the fraction of ethylene radicals being at least 50 mol %;
R⁶ is hydrogen, C₁-C₄ alkyl, —SO₃M or —PO₃M₂;
R⁷ is hydrogen or —CH₂—CR¹═CH₂;
R⁸ is —O—[R⁵—O]ₙ—R⁶, it being possible for the radicals —[R⁵—O]ₙ— to be different from the other radicals —[R⁵—O]ₙ— present in formula I;
R⁷ is hydrogen or ethyl;
M is alkali metal or hydrogen, preferably hydrogen,
m is 1 to 250, preferably 2 to 50, more preferably 3 to 10; and
x is 0 or 1.

Examples of crosslinking monomers comprise molecules having two or more ethylenically unsaturated groups, examples being di(meth)acrylates such as ethylene glycol di(meth)acrylate or butane-1,4-diol di(meth)acrylate or poly(meth)acrylates such as trimethylolpropane tri(meth)acrylate or else di(meth)acrylates of oligoalkylene or polyalkylene glycols such as di-, tri- or tetraethylene glycol di(meth)acrylate. Further examples comprise vinyl (meth)acrylate or butanediol divinyl ether.

The skilled worker makes an appropriate selection from the monomers (C) in accordance with the desired properties of the polymer and in accordance with the desired application of the polymer.

For use for treating metallic surfaces it is preferred as monomer (C) to use monomers containing phosphonic acid and/or phosphoric acid groups, particularly vinylphosphonic acid or its salts and/or its C₁ to C₈ esters. Particularly preferred monomers (C) are vinylphosphonic acid or its salts and/or its C₁ to C₈ esters.

For use for fiber binding, particularly suitable comonomers (C) are (meth)acrylic esters such as, for example, methyl (meth)acrylate, ethyl (meth)acrylate, propyl (meth)acrylate or butyl (meth)acrylate.

The amount of all monomers (C) employed together amounts to 0% to 40% by weight, in particular 0 to 30% by weight, based on the total amount of all monomers employed for the process. Preferably the amount is 0% to 20% by weight, more preferably 1% to 15% and very preferably 2% to 10% by weight. If crosslinking monomers (C) are present their amount should generally not exceed 5%, preferably 2% by weight, based on the total amount of all monomers employed for the process. The amount can for example be from 10 ppm to 1% by weight.

Monomers (C) comprising phosphonic acid and/or phosphoric acid groups, in particular vinylphosphonic acid or salts thereof and/or C₁ to C₈ esters thereof, can also advantageously be used in relatively large amounts. When such monomers (C) are used, amounts of 5% to 40% by weight, preferably 10% to 30% by weight, more preferably 15% to 28%, and very preferably 20% to 25% by weight.

The monomers used are polymerized free-radically in aqueous solution.

The term “aqueous” means that the solvent or diluent used comprises water as its main constituent. In addition, however, there may also be fractions of water-miscible organic solvents and, if appropriate, small amounts of emulsifiers. This may be advantageous in order to improve the solubility of certain monomers, particularly of monomers (C), in the reaction medium.

The solvent or diluent used accordingly comprises at least 50% by weight of water, based on the total amount of solvent. In addition it is possible to use one or more water-miscible solvents. Mention may be made here in particular of alcohols, examples being monoalcohols such as ethanol, propanol or isopropanol, dialcohols such as glycol, diethylene glycol or polyalkylene glycols, and derivatives thereof. Preferred alcohols are propanol and isopropanol. Preferably the water fraction is at least 70% by weight, more preferably at least 80% by weight, very preferably at least 90% by weight. With very particular preference water is employed exclusively.

The amount of each of the monomers used is chosen by the skilled worker so that the monomers are soluble in the particular solvent or diluent used. Monomers of relatively poor solubility, accordingly, are used by the skilled worker only to the extent to which they are soluble. If appropriate it is possible to add small amounts of emulsifiers for the purpose for increasing the solubility.

In accordance with the invention the polymerization is performed in the presence of 2 to 19.9 mol % of at least one amine. This figure is based on the total amount of all COOH groups of the monocarboxylic acid (A) and of the dicarboxylic acids (B). Other acidic groups that may be present are disregarded. In other words, therefore, the COOH groups are partly neutralized. It is of course also possible to use a mixture of two or more organic amines.

The amines used may have one or more primary and/or secondary and/or tertiary amino groups and also the corresponding number of organic groups. The organic groups can be alkyl, aralkyl, aryl or alkylaryl groups. Preferably they are straight-chain or branched alkyl groups. The amines may additionally contain further functional groups. Preferred such functional groups include OH groups and/or ether groups. It is also possible to use amines which are not readily water-soluble per se, since in contact with the acidic monomers ammonium ions are formed and this advantageously raises the water solubility. The amines can also be ethoxylated.

Examples of suitable amines comprise linear, cyclic and/or branched C₁-C₈ mono-, di- and trialkylamines, linear or branched C₁-C₈ mono-, di- or trialkanolamines, especially mono-, di- or trialkanolamines, linear or branched C₁-C₈ alkyl ethers of linear or branched C₁-C₈ mono-, di- or trialkanolamines, and oligoamines and polyamines such as diethylentriamine, for example.

The amines can also be heterocyclic amines, such as, for example, morpholine, piperazine, imidazole, pyrazole, triazoles, tetrazoles and piperidine, for example. With particular advantage it is possible to use heterocycles which have corrosion inhibition properties. Examples comprise benzotriazole and/or tolyltriazole. By means of this combination it is possible to improve corrosion control properties further.

Additionally it is also possible to use amines which contain ethylenically unsaturated groups, especially monoethylenic amines. Amines of this kind perform a dual function, as amine for neutralizing and as monomer (C). By way of example allylamine can be used.

The skilled worker makes an appropriate selection from the amines.

Preference is given to amines having only one amino group. Preference is further given to linear or branched C₁-C₈ mono-, di- or trialkanolamines, particular preference being given to mono-, di- or triethanolamine and/or the corresponding ethoxylated products.

The amount of amine used is preferably 2 to 18 mol %, more preferably 3 to 16 mol % and very preferably 4 to 14 mol %. Very particular preference is given to 5 to 7 mol % and 11 to 14 mol %.

The amine can be added before or during the polymerization. Preferably it is added before, or at the latest when the polymerization is commenced. The base can be added either all at once or over a period of time which corresponds at maximum to the entire reaction period. The amine can be added to the monomer feed, either to the monocarboxylic acid or the dicarboxylic acid, or both, and metered in with them. In other words, therefore, the carboxylic acids are metered in partly in the form of the corresponding ammonium salts. Preferably the amine is metered directly into the initial charge. In order to carry out the polymerization it has proven appropriate to include the dicarboxylic acid or, where appropriate, its cyclic anhydride in the initial charge and thereafter to meter in the amine, before further monomers and/or initiator are metered in, without any intention that this procedure should define the invention.

The free-radical polymerization is preferably initiated by using suitable thermally activatable polymerization initiators. Alternatively it can be triggered by means, for example, of appropriate radiation. The free-radical initiators should be soluble in the reaction solvent, preferably water-soluble.

Among the thermally activatable polymerization initiators preference is given to initiators having a decomposition temperature in the range from 30 to 150° C., in particular from 50 to 120° C. This temperature figure is based, as usual, on the 10 h half-life.

All compounds which break down into radicals under the polymerization conditions can be used as initiators, such as, for example, inorganic peroxo compounds, such as peroxodisulfates, especially ammonium peroxodisulfate, potassium peroxidisulfate and preferably sodium peroxodisulfate, hydroperoxides, peroxosulfates, percarbonates and hydrogen peroxide and what are called redox initiators. Preference is given to the use of water-soluble initiators. In many cases it is advantageous to employ mixtures of different initiators; for example, mixtures of hydrogen peroxide and sodium peroxodisulfate or potassium peroxodisulfates. Mixtures of hydrogen peroxide and sodium peroxodisulfate can be employed in any desired ratio.

Suitable organic peroxo compounds are diacetyl peroxide, di-tert-butyl peroxide, diamyl peroxide, dioctanoyl peroxide, didecanoyl peroxide, dilauroyl peroxide, dibenzoyl peroxide, bis(o-toloyl) peroxide, succinyl peroxide, tert-butyl peracetate, tert-butyl permaleate, tert-butyl perisobutyrate, tert-butyl perpivalate, tert-butyl peroctoate, tert-butyl perneodecanoate, tert-butyl perbenzoate, tert-butyl peroxide, tert-butyl hydroperoxide, cumene hydroperoxide, tert-butyl peroxy-2-ethylhexanoate and diisopropyl peroxydicarbamate.

Preferred initiators are, furthermore, azo compounds. These may be soluble in organic solvents, as in the case for example of 2,2′-azobis(4-methoxy-2,4-dimethylvaleronitrile), dimethyl 2,2′-azobis(2-methylpropionate), 1,1′-azobis(cyclohexane-1-carbonitrile), 1-[(cyano-1-methylethyl)azo]formamide, 2,2′-azobis(N-cyclohexyl-2-methylpropionamide), 2,2′-azobis(2,4-dimethylvaleronitrile), 2,2′-azobis(2-methylbutyronitrile), 2,2′-azobis[N-(2-propenyl)-2-methylpropionamide], and 2,2′-azobis(N-butyl-2-methylpropionamide). Preference is given to using water-soluble compounds, such as 2,2′-azobis[2-(5-methyl-2-imidazolin-2-yl)propane] dihydrochloride, 2,2′-azobis[2-(2-imidazolin-2-yl)propane] disulfatedihydrate, 2,2′-azobis[N-(2-carboxyethyl)-2-methyl-propionamidine] tetrahydrate, 2,2′-azobis{2-[1-(2-hydroxyethyl)-2-imidazolin-2-yl]propane} dihydrochloride, 2,2′-azobis{2-methyl-N-[1,1-bis(hydroxymethyl)-2-hydroxyethyl]propionamide}, 2,2′-azobis[2-methyl-N-(2-hydroxyethyl)propionamide], 2,2′-azobis[2-(2-imidazolin-2-yl)propane] dihydrochloride, 2,2′-azobis(2-methylpropionamide) dihydrochloride, 2,2′-azobis[2-(3,4,5,6-tetrahydropyrimidin-2-yl)propane] dihydrochloride, 2,2′-azobis[2-(2-imidazoline-2-yl)propane], and 2,2′-azobis{2-methyl-N-[2-(1-hydroxybutyl)]propionamide}, for example.

Additionally preferred initiators are redox initiators. The redox initiators comprise as oxidizing component at least one of the peroxo compounds as specified above and as reducing component, for example, ascorbic acid, glucose, sorbose, ammonium or alkali metal hydrogen sulfite, sulfite, thiosulfate, hyposulfite, pyrosulfite or sulfide, or sodium hydroxymethylsulfoxylate. As a reducing component in the redox catalyst it is preferred to use ascorbic acid or sodium pyrosulfite. Based on the amount of monomers employed in the polymerization use is made for example of 1×10⁻⁵ to 1 mol % of the reducing component of the redox catalyst.

In combination with the initiators and/or the redox initiator systems it is possible in addition to use transition metal catalysts, examples being salts of iron, cobalt, nickel, copper, vanadium and manganese. Suitable salts are, for example, iron(II) sulfate, cobalt(II) chloride, nickel(II) sulfate and copper(I) chloride. The transition metal salt with reducing action is usually used in an amount of 0.1 to 1000 ppm, based on the sum of the monomers. Particular advantage is possessed, for example, by combinations of hydrogen peroxide and iron(II) salts, such as a combination of 0.5% to 30% by weight of hydrogen peroxide and 0.1 to 500 ppm of FeSO₄×7H₂O, based in each case on the sum of the monomers.

Examples of suitable photoinitiators comprise acetophenone, benzoin ethers, benzyl dialkyl ketones and derivatives thereof.

It is preferred to use thermal initiators, preference being given to water-soluble azo compounds and water-soluble peroxo compounds. Particular preference is given to inorganic peroxo compounds, especially hydrogen peroxide and in particular sodium peroxodisulfate or mixtures thereof, optionally in combination with 0.1 to 500 ppm FeSO₄×7H₂O. Very particular preference is given to hydrogen peroxide.

It is of course also possible to use mixtures of different initiators, provided they do not adversely affect one another. The amount is determined by the skilled worker in accordance with the desired copolymer. Generally speaking 0.05% to 30%, preferably 0.1% to 15%, and more preferably 0.2% to 8% by weight of the initiator is used, based on the total amount of all monomers.

Furthermore, in a way which is known in principle, it is also possible to use suitable regulators, such as mercaptoethanol, for example. Preferably no regulators are used.

In accordance with the invention the polymerization is performed at a temperature of less than 130° C. This ensures that the polymers have a sufficient molecular weight M_{w}, but at least an M_{w} of 3000 g/mol.

Apart from this the temperature can be varied by the skilled worker within wide limits, depending on the nature of the monomers used, the nature of the initiator, and the desired copolymer. A minimum temperature which has proven appropriate here is a temperature of about 60° C. The temperature can be kept constant during the polymerization or else temperature profiles can be run.

Preferably the polymerization temperature is 75 to 125° C., more preferably 80 to 120° C., very preferably 90 to 110° C., and, for example, 95 to 105° C.

The polymerization can be performed in customary apparatus for free-radical polymerization. When operating above the boiling temperature of water or of the mixture of water and further solvents, a suitable pressure vessel is used; otherwise, the polymerization can be operated unpressurized.

In the course of the polymerization it has regularly proven appropriate to include the dicarboxylic acid and/or corresponding anhydrides in the initial charge in the form of an aqueous solution. After that the amine, appropriately in the form of an aqueous solution, can be added. In aqueous solution, particularly in the presence of the amine, the carboxylic anhydrides undergo more or less quick hydrolysis to form the corresponding dicarboxylic acids. Thereafter it is possible to meter in the monocarboxylic acid, further monomers (C) if appropriate, and the initiator, appropriately likewise in the form of an aqueous solution. Feed times which have proven appropriate are from 0.5 h to 24 h, preferably 1 h to 12 h and more preferably 2 to 8 h. In this way the concentration of the more readily reacting monocarboxylic acids in the aqueous solution is kept relatively low. This reduces the tendency for the monocarboxylic acid to react with itself, and the resulting incorporation of the dicarboxylic acid units into the copolymer is more uniform. The feeding of all of the monomers may be followed by an afterreaction time, of 0.5 to 3 h, for example. This ensures that the polymerization reaction proceeds as far as possible to completion. Completion can also be achieved by metering in polymerization initiator again.

The skilled worker, however, can of course also perform the polymerization in another way.

Not only carboxylic anhydrides but also other monomers used which contain hydrolyzable groups, such as esters, for example, may under certain circumstances undergo complete or partial hydrolysis, depending on the polymerization conditions. The copolymers then contain the monomers with the acid group resulting from the hydrolysis, in copolymerized form, or else contain both unhydrolyzed groups and hydrolyzed groups alongside one another.

The copolymers synthesized can be isolated from the aqueous solution by means of customary methods known to the skilled worker: for example, by evaporating down the solution, by spray drying, by freeze drying or by precipitation. The polymers can of course also be purified by means of purification methods known to the skilled worker, as for example by ultra-filtration.

With particular preference, however, the copolymers are not isolated from the aqueous solution at all after the polymerization, and also not purified; instead, the resultant solutions of the copolymer solutions are used as they are.

In order to facilitate such direct ongoing use the amount of aqueous solvent should from the start be such that the concentration of the polymer in the solvent is appropriate for the application. A concentration which has proven particularly appropriate is that from 15 to 70% by weight, based on the sum of all components, preferably 20% to 65%, more preferably 25% to 60%, and, for example, 45% to 55% by weight.

By means of the process of the invention it is possible to obtain partly neutralized, carboxylate-rich copolymers.

The composition of the copolymers corresponds substantially to the ratio of the monomers (A), (B) and, optionally, (C) employed. As a general rule, therefore, the copolymers comprise 30% to 79.99% by weight of monoethylenically unsaturated monocarboxylic acids, 20.01% to 70% by weight of monoethylenically unsaturated dicarboxylic acids of the general formula (HOOC)R¹C═CR²(COOH) (I) and/or R¹R²C═C(—(CH₂)ₙ—COOH)(COOH) (II), and, if appropriate, 0% to 30% by weight of further, ethylenically unsaturated comonomers (C), R¹, R² and n being as defined above.

Where hydrolyzable derivatives of the monomers (B) have been used the polymer, depending on the rate of hydrolysis and on the conditions, may also comprise fractions of unhydrolyzed monomers.

Despite the small amount of base the process of the invention leads nevertheless to copolymers which contain only small amounts of uncopolymerized dicarboxylic acids.

The residual fraction of uncopolymerized dicarboxylic acids in the product is lower than when other bases are used.

Even in the case of polymers having relatively high dicarboxylic acid contents, the residual content is generally not more than 2% by weight, based on the copolymer.

The residual amount of monocarboxylic acids (A) is likewise very low, and is generally not more than 0.1% by weight, based on the copolymer.

In general the copolymers have a degree of neutralization of the COOH groups of all monocarboxylic and dicarboxylic acid units of 2 to 19.9 mol %, relative to the total amount of all COOH groups in the monocarboxylic and/or dicarboxylic acid units. In general the degree of neutralization is a simple product of the amount of amine originally added. Depending on the nature of the amine, however, particularly its volatility and basicity, it is also possible for small amounts of the amine to be lost in the course of the polymerization and/or workup. When basic monomers (C) are used the degree of neutralization may under certain circumstances also be higher than apparent from the amount of amine. Within the product the amines are generally in the form of ammonium ions, although depending on the amine's basicity it is also possible for there to be certain fractions of the amine in unprotonated form in the product.

The copolymers of the invention are soluble or at least dispersible in water or in aqueous solvent mixtures comprising at least 50% by weight of water, the skilled worker being aware that the solubility of COOH-rich polymers can be heavily pH-dependent. The term “water-dispersible” means that although the solution is not entirely clear the polymer is nevertheless homogeneously distributed therein and also does not settle. The copolymers in question are preferably water-soluble.

The pH of the polymers is generally less than 5, preferably less than 4 and more preferably less than 3.

The molecular weight M_{w} (weight average) of the copolymers of the invention is at least 3000 g/mol, preferably at least 5000 g/mol, more preferably at least 8000 g/mol and very preferably 15 000 g/mol. It is also possible to obtain molecular weights of more than 1 000 000 g/mol. Normally M_{w} is 3000 g/mol to 1 500 000 g/mol, preferably 5000 g/mol to 1 000 000 g/mol, more preferably 8000 g/mol to 750 000 g/mol, and, for example, 15 000 g/mol to 500 000 g/mol. The molecular weight is determined by the skilled worker in accordance with the desired application.

Preferred copolymers comprise acrylic acid and maleic acid as monomers and also, if appropriate, further comonomers (C). Further comonomers can preferably be monomers containing phosphoric or phosphonic acid groups, an example being vinylphosphonic acid, or (meth)acrylic esters such as, for example, methyl (meth)acrylate, ethyl (meth)acrylate, propyl (meth)acrylate or butyl (meth)acrylate.

Particular preference is given to copolymers which comprise acrylic acid, maleic acid and 5 to 40% by weight of monomers (C) comprising phoshonic acid and/or phosphoric acid groups. Monomer (C) is preferably vinylphosphonic acid or salts thereof and/or C₁ to C₈ esters thereof, more preferably vinylphosphonic acid.

A further aspect of the present invention relates to the use of the copolymers of the invention for treating surfaces. These can be, for example, metallic surfaces, or the surface of fibers or textile materials. The high density of unneutralized COOH groups achieves particularly good adhesion for copolymers on the surfaces.

The polymers of the invention can be used in particular for treating metallic surfaces. For this purpose the polymers of the invention can be used in particular as components of corresponding formulations: for example, as components of cleaners, pickling solutions, corrosion inhibitors and/or formulations for passivating.

The copolymers of the invention can be used with particular advantage for passivating metallic surfaces or for forming passivating layers on metals. They are particularly suitable for chromium-free passivation. Instead of the term “passivating layer” the term “conversion coat” is frequently also used synonymously, and sometimes also the term “pretreatment layer” or “post-treatment layer”, depending on at which stage of the process passivation occurs.

Any desired metallic surfaces can be treated, in particular passivated, by means of the polymers of the invention. Preferably, however, the surfaces in question are those of Zn, Zn alloys, Al or Al alloys. These may be the surfaces of structures or workpieces composed entirely of said metals and/or alloys. Alternatively they may be the surfaces of structures coated with Zn, Zn alloys, Al or Al alloys, it being possible for the structures to be composed of other materials: other metals, alloys, polymers or composites, for example. The surface in question may in particular be that of galvanized iron or ungalvanized or galvanized steel. The steel can be high-alloy or low-alloy steels. In one particular embodiment of the process it is the surface of a strip metal, in particular electrolytically galvanized or hot-dip-galvanized steel. In a further-preferred embodiment it may be an automobile body.

Zn alloys or Al alloys are known to the skilled worker. The skilled worker selects the type and amount of alloying constituents in accordance with the desired end application. Typical constituents of zinc alloys for hot-dip processes comprise, in particular, Al, Pb, Si, Mg, Sn, Cu or Cd. Typical alloying components in Zn alloys deposited electrolytically are Ni, Fe, Co and Mn. Typical constituents of aluminum alloys comprise, in particular, Mg, Mn, Si, Zn, Cr, Zr, Cu or Ti. The alloys in question can also be Al/Zn alloys in which Al and Zn are present in approximately equal amount. Steel coated with such alloys is available commercially.

For treating metallic surfaces it is possible with preference to use acrylic acid-maleic acid copolymers having a maleic acid content of 20.01% to 40% by weight, for example 25% to 40% by weight. Further preference is given to terpolymers of 55% to 78%, preferably 65% to 78%, and more preferably 65% to 75% by weight acrylic acid, 20.01% to 34% by weight, preferably 21% to 34%, and more preferably 22% to 30% by weight maleic acid, and 1% to 24.99%, preferably 2% to 24%, and more preferably 5 to 22% by weight vinylphosphonic acid, which in certain circumstances may also be present in part in the form of their esters.

By way of example it is possible to use a terpolymer of 71% to 73% by weight acrylic acid, 23% to 25% by weight maleic acid and 3% to 5% by weight vinylphosphonic acid.

Further examples comprise terpolymers of 55% to 62% by weight acrylic acid, 20.01% to 22% by weight maleic acid and 16% to 24% by weight vinylphosphonic acid and terpolymers of 65% to 70% by weight acrylic acid, 21% to 25% by weight maleic acid and 6% to 12% by weight vinylphosphonic acid.

Preferably copolymers having a relatively high molecular weight M_{w} are used for treating metallic surfaces; in particular, copolymers with M_{w} from 5000 to 1.5 million g/mol, preferably 10 000 to 1 million g/mol, more preferably 20 000 to 800 000 g/mol and very preferably 50 000 to 500 000 g/mol.

Polymers having a molecular weight M_{w} from 10,000 to 100,000 g/mol, preferably 15,000 to 80,000 g/mol, more preferably 20,000 to 50,000 g/mol and for example 20,000 to 30,000 g/mol can be used in the case of acrylic acid/maleic acid/vinylphosphonic acid terpolymers.

The copolymers of the invention are used for treating metallic surfaces preferably in the form of a suitable preparation. The preparation employed comprises at least
one or more copolymers of the invention,
water or an aqueous solvent mixture comprising at least 50% by weight of water, and
optionally further components.

Preferably only water is used as solvent. Further components of a mixture are water-miscible solvents. Examples comprise monoalcohols such as methanol, ethanol or propanol, higher alcohols such as ethylene glycol or polyether polyols and ether alcohols such as butyl glycol or methoxypropanol. If an aqueous mixture is employed the mixture preferably comprises at least 65%, more preferably at least 80% and very preferably at least 95% by weight of water. The figures are based in each case on the total amount of all solvents.

With particular preference the polymer-containing solutions which result immediately from the polymerization are employed. Where appropriate they may also be diluted further and/or further components may be added.

The concentration of the copolymers of the invention in the preparation is determined by the skilled worker in accordance with the desired end application. By way of example the thickness of the passivating layer depends on the process technology chosen for the application, but also, for example, on the viscosity of the composition used for passivating. In general a concentration which has proven appropriate is from 0.01 g/l to 500 g/l, preferably 0.1 g/l to 200 g/l, and more preferably 0.5 g/l to 100 g/l. The stated concentrations are based on the preparation in ready-to-use form. In general it is possible first to prepare a concentrate, which only in situ is diluted with water or, optionally, other solvent mixtures to the desired concentration. Concentrations of 0.1 to 100 g/l have proven suitable in the dipping method. Preparations of relatively high concentration, in particular those having 150 to 300 g/l, have also proven suitable for use in processes in which excess preparation is squeezed out or removed in another manner.

The preparation used in accordance with the invention is acidic. It generally has a pH of 0.5 to 6, it being possible for narrower pH ranges to be chosen depending on the substrate and mode of application and also on the period of time for which the surface is exposed to the preparation. By way of example the pH is adjusted preferably to the range from 1 to 4 for the purpose of treating aluminum surfaces and, when treating zinc or galvanized steel, preferably to the range from 1 to 5.

The pH of the preparation can be controlled by the nature and concentration of the copolymers of the invention, and so comes about automatically.

Alternatively, as an option, the preparation may further comprise at least one organic or inorganic acid or mixtures thereof. Examples of suitable acids comprise phosphorus acids, sulfur acids or nitrogen acids such as phosphoric acid, phosphonic acid, sulfuric acid, sulfonic acids such as methanesulfonic acid, amidosulfonic acid, p-toluene-sulfonic acid, m-nitrobenzenesulfonic acid and derivatives thereof, nitric acid, hydrofluoric acid, hydrochloric acid, formic acid or acetic acid. The acid is preferably selected from the group consisting of HNO₃, H₂SO₄, H₃PO₄, formic acid or acetic acid. Particular preference is given to H₃PO₄ and/or HNO₃. It is of course also possible to use mixtures of different acids. Examples of phosphonic acids comprise 1-hydroxyethane-1,1-diphosphonic acid (HEDP), 2-phosphonobutane-1,2,4-tricarboxylic acid (PBTC), aminotri(methylenephosphonic acid) (ATMP), ethylenediaminetetra(methylenephosphonic acid) (EDTMP) or diethylenetriaminepenta(methylenephosphonic acid) (DTPMP).

The nature and concentration of the acid in the preparation is determined by the skilled worker in accordance with the desired end application and pH. A concentration which has proven appropriate is generally from 0.01 g/l to 30 g/l, preferably 0.05 g/l to 3 g/l, and more preferably 0.1 g/l to 5 g/l.

Beyond the stated components the preparation may also, optionally, comprise further components.

The components present optionally may be, for example, transition metal ions and transition metal compounds, such as those of Ce, Ni, Co, V, Fe, Zn, Zr, Ca, Mn, Mo, W, Ti, Zr, Hf, Bi, Cr and/or of the lanthanides, for example. They may also be compounds of main group elements, such as Si and/or Al, for example. The compounds can be used for example in the form of the respective aqua complexes. Alternatively they may be complexes with other ligands, such as fluoride complexes of Ti(IV), Zr(IV) or Si(IV), for example, or oxometallates such as MoO₄²⁻ or WO₄²⁻, for example. They may also be oxides, such as ZnO, for example. In addition it is also possible to use complexes with typical chelate-forming ligands such as ethylenediaminetetraacetic acid (EDTA), diethylenetriaminepentaacetic acid (DTPA), hydroxyethylethylenediaminetriacetic acid (HEDTA), nitrilotriacetic acid (NTA) or methylglycinediacetic acid (MGDA).

Additional components may be, preferably, a dissolved metal ion selected from the group of Zn²⁺, Mg²⁺ or Ca²⁺. The ions may be in the form of hydrated metal ions or alternatively may be in the form of dissolved compounds, complex compounds for example. In particular the ions may have complex bonds to the acidic groups of the polymer. Preferably the species in question is Zn²⁺ or Mg²⁺, and with very particular preference it is Zn²⁺. The preparation preferably comprises no further metal ions besides this.

If further metal ions or metal compounds are to be present, however, the preparations in question are preferably preparations comprising no chromium compounds. Furthermore, preferably, there ought to be no metal fluorides or complex metal fluorides present. The passivation using the polymers of the invention is therefore, preferably, a chromium-free passivation, more preferably a chromium-free and fluoride-free passivation.

In the context of the inventive use it is further preferred not to use any heavy metal ions other than those of zinc and of iron, and in particular no ions of nickel of manganese, and of cobalt.

If present, the amount of the metal ions from the group of Zn²⁺, Mg²⁺ or Ca²⁺ is 0.01% to 25%, preferably 0.5% to 20%, more preferably 1% to 15%, and very preferably 3% to 12%, in each case by weight based on the total amount of all polymers in the formulation.

The metal ions from the group of Zn²⁺, Mg²⁺ or Ca²⁺ are preferably used as phosphates. The phosphates in question may be any kinds of phosphates. By way of example they may be orthophosphates or diphosphates. For the skilled worker it is clear that, in aqueous solution, depending on pH and concentration, there may be an equilibrium between the various dissociation states of the ions. Examples of suitable compounds comprise Zn₃(PO₄)₂, ZnH₂PO₄, Mg₃(PO₄)₂ or Ca(H₂PO₄)₂, or corresponding hydrates thereof.

Zinc ions and phosphate ions may alternatively be added separately from one another. By way of example it is possible to use the metal ions in the form of the corresponding nitrates, and the phosphates can be used in the form of phosphoric acid. It is also possible to use insoluble or sparingly soluble compounds, examples being the corresponding carbonates, oxides, oxide hydrates or hydroxides, which are dissolved under the influence of acid.

If present, the amount of the phosphate ions in the formulation is generally 0.01% to 25%, preferably 0.5% to 25%, more preferably 1% to 25%, and very preferably 5% to 25%, by weight reckoned in each case as orthophosphoric acid and based on the total amount of the polymers in the formulation.

Further optional components comprise surface-active compounds, corrosion inhibitors, typical electroplating assistants or else other polymers different from the polymers of the invention.

The skilled worker makes an appropriate selection from among the optional components that are possible in principle, and the amounts thereof, in accordance with the desired application.

Examples of further corrosion inhibitors comprise butynediol, propargyl alcohol and their ethoxylated derivatives, and also heterocycles such as benzotriazole and tolyltriazole. The latter compounds can be used with particular advantage as bases during the actual synthesis of the copolymers.

Examples of further components comprise amines, such as hydroxylamine, alkylamines and alkanolamines, for example, or salts, such as nitrites or nitrates, for example.

Further polymers may be used to fine-tune the properties of the layer. In this context it is possible in particular to use polymers containing acidic groups and, very preferably, polymers comprising COOH groups. Examples of such polymers comprise polyacrylic acids of various molecular weight or else copolymers of acrylic acid and other acidic monomers. These can also be acrylic acid/maleic acid copolymers, which differ merely in terms of monomer content from the copolymers of the invention.

The amount of such secondary polymers should generally not exceed 50% by weight, based on the amount of all polymers employed. Preferably their amount is 0% to 30%, more preferably 0% to 20% and very preferably 0% to 10% by weight.

For the passivation of metallic surfaces the surface of the metal is treated with the preparation by means for example of spraying, dipping or rolling. After a dipping operation excess treatment solution can be removed from the workpiece by allowing it to drip dry; in the case of metal sheets, metal foils or the like, excess treatment solution can alternatively be removed by squeezing off or squeegeeing, for example. In the course of the treatment at least parts of the polymer used and also further components of the preparation are chemisorbed by the surface of the metal and/or react with the surface, so that a solid bond comes about between the surface and the components. Treatment with the preparation takes place generally at room temperature, although this is not intended to rule out the possibility of higher temperatures in principle. In general the treatment takes place at 20 to 90° C., preferably 25 to 80° C. and more preferably 30 to 60° C. For this purpose the bath with the formulation can be heated, or else an elevated temperature may come about automatically, by the immersion of hot metal into the bath.

The passivation is preferably a substantially chromium-free passivation. This is intended to denote that small amounts, at most, of chromium compounds, for the purpose of fine-tuning the properties of the passivating layer, could be added. The amount ought not to exceed 2%, preferably 1% and more preferably 0.5% by weight of chromium, based on all constituents of the composition. If chromium compounds are to be used then preferably Cr(III) compounds should be used. The Cr(VI) content, however, should in any case be kept so low that the Cr(VI) content on the passivated metal does not exceed 1 mg/m².

With particular preference the passivation is a chromium-free passivation, i.e., the preparation used comprises no Cr compounds whatsoever. The term “chromium-free”, however, does not rule out the entrainment of small amounts of chromium into the process indirectly and unintentionally per se. For instance, where alloys are passivated, using the process of the invention, that comprise chromium as an alloying constituent, Cr-containing steel for example, it is always within the bounds of possibility that small amounts of chromium in the metal to be treated will be dissolved by the preparation used for the process and may therefore pass into the preparation unintentionally per se. Even in the case where such metals are used, with the resultant consequences, the process should still be regarded as being “chromium-free”.

The treatment can be a “no-rinse” operation, in which the treatment solution is dried directly in a drying oven immediately following its application, without rinsing. It is also possible, however, to rinse the surface, after treatment, with a cleaning liquid, in particular with water, in order to remove residues of the preparation used from the surface.

The treatment of the metal surface with the preparation can take place discontinuously or, preferably, continuously. A continuous process is particularly suitable for treating strip metals. The metal strip in this case is run through a trough or a spraying apparatus with the preparation and also, optionally, through further pretreatment or aftertreatment stations. A continuous process for producing steel strips can comprise, for example, a galvanizing station, followed by an apparatus for passivating with the preparation.

The treatment time is determined by the skilled worker in accordance with the desired properties of the layer, of the composition used for the treatment, and with the technical boundary conditions. It may be substantially less than one second or two or more minutes. In the case of the continuous process it has proven particularly appropriate to contact the surface with the preparation for a time of 1 to 60 s.

Following the treatment the solvent used is removed. Its removal can take place at room temperature by simple evaporation in air at room temperature.

Alternatively the removal of the solvent can be assisted by means of suitable auxiliary means: for example by heating and/or by passing streams of gas, in particular streams of air, over the treated surface. The evaporation of the solvent can be assisted by means, for example, of IR emitters, or else, for example, by drying in a drying tunnel. A temperature which has proven appropriate for drying is that from 30° C. to 210° C., preferably 40° C. to 120° C. and more preferably 40° C. to 80° C. This refers to the peak temperature found on the metal (Peak metal temperature (PMT)), which can be measured by methods familiar to the skilled worker (for example contact-less infrared measurement or determination of the temperature with adhesively bonded test strips). The dryer temperature must be set higher, if appropriate, and is chosen accordingly by the skilled worker.

The process of the invention may optionally also comprise one or more pretreatment steps. By way of example the metallic surface, prior to passivation with the preparation used in accordance with the invention, can be cleaned, in order for example to remove greases or oils. It can also be pickled prior to passivation, in order to remove oxide deposits, scale, a temporary corrosion protection and the like. Furthermore the surface must be rinsed, if appropriate with water as well, after and between such pretreatment steps, and to remove the residues of rinsing solutions or pickling solutions.

The passivating layer may also be crosslinked additionally. For this purpose a crosslinker can be admixed to the preparation. An alternative option is first to treat the metal with the preparation and then to treat the layer with a suitable crosslinker: for example, to spray it with the solution of a crosslinker.

Suitable crosslinkers ought to be water-soluble or at least soluble in said aqueous solvent mixture. Examples of suitable crosslinkers comprise, in particular, those which contain at least 2 crosslinking groups selected from the group of azirane groups, oxirane groups or thiirane groups. Further details of suitable crosslinkers are disclosed in our as yet unpublished application DE 103 49 728.5, expressly incorporated by reference at this point.

By means of the process of the invention a passivating layer is obtainable in particular on a metallic surface comprising Zn, Zn alloys, Al or Al alloys. In the course of such a treatment a part of the metal to be protected dissolves and immediately is reincorporated into an oxidic film on the metal surface. The precise structure and composition of the passivating layer is unknown to us. However, as well as the customary amorphous oxides of aluminum or of zinc and, where appropriate, of further metals, it also comprises the reaction products of the polymer and, if appropriate, of the crosslinker and/or of further components of the formulation. The composition of the passivating layer is generally not homogeneous; rather, the components appear to exhibit concentration gradients.

The combination of a high COOH group content and a low degree of neutralization produces particularly acidic polymers, as a result of which the abovementioned “incipient dissolution” of the metal surface proceeds to particularly good effect and an excellent corrosion protection results.

The thickness of the passivating layer is adjusted by the skilled worker in accordance with the desired properties of the layer. In general the thickness is 0.01 to 3 μm, preferably 0.1 to 2.5 μm, more preferably 0.2 to 2 μm, very preferably 0.3 to 1.5 μm and for example 1 to 2 μm. The thickness can be influenced, for example, via the nature and amount of the components applied and also by way of the exposure time. In addition it is possible to use technical parameters of the process to influence the thickness: by using rollers or squeegees to remove treatment solution applied in excess, for example.

The thickness of the layer is ascertained by differential weighing before and after exposure of the metal surface to the composition used in accordance with the invention, on the assumption that the layer has a specific density of 1 kg/l. In the text below “layer thickness” always refers to a variable determined in this way, irrespective of the actual specific density of the layer. These thin layers are enough to obtain outstanding corrosion protection. Thin layers of this kind ensure that the dimensions of the passivated workpieces are maintained.

The present specification further provides a metallic surface which comprises the passivating layer of the invention. The passivating layer is applied directly on the actual metal surface. In one preferred embodiment the metal surface in question is that of a strip metal made of steel, which comprises a coating of Zn or a Zn alloy and on which a passivating layer of the invention has been applied. It may also be an automobile body which has been coated with the passivating layer of the invention.

The metallic surface with its passivating layer may in principle be overcoated in a known manner with one or more color or effect paint layers. Typical paints, their composition and typical layer sequences in the case of two or more paint layers are known in principle to the skilled worker. In this context it is found that the passivation of the invention improves the adhesion of the paint and generates a protection against subfilm migration.

The passivation with inventive use of the polymers can be employed at different stages of processing. It can be performed, for example, at the premises of a steelmaker. In that case a steel strip can be galvanized in a continuous process and, immediately after galvanizing, can be passivated by treatment with the formulation used in accordance with the invention. Passivation at this stage is frequently referred to by the skilled worker as an “aftertreatment”.

The passivation in question may be only a temporary passivation, serving to protect against corrosion during storage and transport and/or during further process steps, and is removed again before the permanent corrosion protection is applied. The acidic copolymers can be removed from the surface again by cleaning with aqueous alkaline solutions.

Alternatively the corrosion protection treatment may be a permanent treatment, which remains on the coil or finished shaped workpiece and is provided with additional paint layers. Passivation at this stage is frequently referred to by the skilled worker as a “pretreatment”.

The passivated and, if appropriate, painted metal sheets, strips or other semifinished metallic products can be processed further to metallic workpieces, such as an automobile body, for example. In general this necessitates at least one separating step and a forming step. Larger components can be assembled thereafter from individual parts. Forming involves a change in the shape of the material, generally in contact with a tool. The shaping may for example be compressive shaping, such as rolling or embossing, tensile compressive forming, such as cold drawing, deep drawing, plunging or spinning, tensile forming such as lengthening or widening, flexural forming such as bending, roll-bending or edge-bending, and shear forming such as twisting or dislocating.

Through the use of the copolymers of the invention with a low degree of neutralization passivating layers are obtained whose corrosion protection effect is significantly higher than when known homopolymers or copolymers of acrylic acid and/or maleic acid with a higher degree of neutralization are used.

A further advantage of the inventive treatment of the metal strip is that said strip is protected even in the unpainted state against the formation of white rust, without it being necessary to use chromate-containing reagents or hexafluorometallates. Hexafluorometallates are active only in mixtures of complex composition, whose composition must be continually examined during the operation and kept within a narrow frame by subsequent metering of individual components. In the case of the processes of the invention such subsequent metering, advantageously, can be omitted.

A further aspect of the present invention relates to the use of the copolymers of the invention for binding substrates, particularly for binding fibrous and/or granular substrates. Examples of such substrates comprise fibers, slivers or chips of various natural and/or synthetic materials.

For substrate binding it is possible with preference to use acrylic acid-maleic acid copolymers having a maleic acid content of 25% to 50% by weight, examples being such copolymers containing 25%, 30% or 50% by weight of maleic acid.

For substrate binding it is preferred to use copolymers not having too high a molecular weight M_{w}, particularly copolymers with an M_{w} of 3000 to 500 000 g/mol, preferably 5000 to 250 000 g/mol, more preferably 8000 to 120 000 g/mol and very preferably 10 000 to 100 000 g/mol.

For the binding of substrates the copolymers of the invention are preferably used as components of binder formulations, especially thermally curable binder formulations, which comprise at least
one or more copolymers of the invention,
one or more crosslinkers, and also
optionally a suitable solvent or solvent mixture, and
optionally further components.

The binding can take place, for example, by mixing chips, slivers or the like with the binder formulation to form moldings, such as sheets for example, which are shaped and cured. It is also possible first to shape moldings and then to treat them with the binder formulation and effect curing. One example of such are moldings of fibrous materials, such as nonwovens, wovens or mats, for example, which are mechanically reinforced using the binder formulation.

The solvent of the formulation is preferably water or an aqueous solvent mixture, in particular an aqueous solvent mixture comprising at least 50% by weight of water, as defined above.

With particular advantage it is possible to use, without further workup and/or purification, the solutions of the copolymers of the invention as they result directly from the polymerization. If appropriate they can also be diluted further and/or further components can be added.

Crosslinkers whose suitability is known in principle are compounds which contain at least 2 functional groups which are able to react with the copolymers of the invention. Where a solvent is used it ought to be soluble in the solvent or solvent mixture. Preferably the crosslinkers used are water-soluble. In general the crosslinkers react only at elevated temperature with the copolymers of the invention, without any intention that the invention should be restricted thereto. It is of course also possible to use mixtures of two or more different crosslinkers.

Examples of suitable crosslinkers comprise in particular compounds which have at least 2 OH groups. These react at elevated temperature with the COOH groups of the copolymer used in accordance with the invention, and esterification takes place. The H⁺ ions of further COOH groups serve as an esterification catalyst. As a result of the high COOH group content and low degree of neutralization of the copolymers used in accordance with the invention the acidic catalysis proceeds, advantageously, with particular efficiency. A high degree of crosslinking is obtained even under comparatively mild conditions.

Examples of compounds having at least 2 OH groups comprise simple polyalcohols such as, for example, trimethylolpropane, pentaerythritol, neopentyl glycol, glucose, sorbitol, hexanediol, glycerol or polyvinyl alcohol. Further details of crosslinkers based on alkanols are disclosed for example in WO 97/31059.

The compounds having at least 2 OH groups can preferably also comprise further functional groups. Mention may be made here in particular of amino groups. Examples of such crosslinkers comprise di- or trialkanolamines such as, for example, diethanolamine, triethanolamine, diisopropanolamine, triisopropanolamine, methyl-diethanolamine, butyldiethanolamine or methyldiisopropanolamine. Particular preference is given to triethanolamine.

The particular advantage of crosslinkers of this kind with additional basic groups is that they can with advantage be used already as bases in the course of the preparation of the copolymer. In that case the prepared copolymer already comprises the entire crosslinker or at least part of the crosslinker.

Use may also be made of crosslinkers with other functional groups, such as with primary amino groups, for example. Examples comprise polyamines or else amino acids such as lysine. It is of course also possible to use mixtures of different crosslinkers.

The copolymers of the invention and the crosslinkers are usually used in a ratio to one another such that the molar ratio of carboxyl groups of the copolymers of the invention that are employed to the crosslinking groups of the crosslinkers, in other words the OH groups for example, is 20:1 to 1:1, preferably 8:1 to 5:1 and more preferably 5:1 to 1.7:1.

If crosslinkers with basic groups are used it has proven particularly appropriate to limit their amount so that even after the crosslinker has been added the equivalent degree of neutralization of the polymers used in accordance with the invention does not exceed 19.9 mol %, based on the COOH groups, although the invention is not restricted to this. In this way, nonwovens are obtained whose strength is particularly good.

The binder formulations can be prepared, for example, by simple mixing of the crosslinkers with the copolymers of the invention or with an aqueous solution of the copolymers of the invention. A particularly suitable aqueous solution is the copolymer solution obtained by means of the polymerization.

The crosslinker can be added as early as immediately after the end of polymerization, and this mixture held ready for use. Alternatively, of course, the crosslinker can be added not until a later point in time, prior to use. Where crosslinkers with amino groups are used, such as triethanolamine, for example, the addition can be added advantageously in the course of the actual polymerization. It then fulfils a dual function as crosslinker and as amine in the course of the polymerization.

The binder formulations may optionally comprise further components. The identity and amount of such components are guided by the respective end application.

By way of example it is possible to use reaction accelerants, especially phosphorus reaction accelerants. Further details of such accelerants are disclosed in WO 97/21059, page 11. Preferably no phosphorus reaction accelerants are present.

Additionally it is possible to use esterification catalysts, such as sulfuric acid or p-toluenesulfonic acid. Preferably no additional acidic esterification catalysts are present.

Further components comprise, for example, dyes, pigments, biocides, plasticizers, thickeners or adhesion promoters, examples being alkoxysilanes, such as γ-aminopropyltriethoxysilane, reducing agents and transesterification catalysts or flame retardants such as aluminum silicates, aluminum hydroxides, or borates, ionic or nonionic emulsifiers, hydrophobicizers such as silicones, for example, or retention agents.

It is also possible to use additional polymers different from the polymers of the invention. In this context it is possible in particular to use polymers comprising acidic groups and, very particularly, polymers comprising COOH groups. Examples of such polymers comprise polyacrylic acids of various molecular weights or else copolymers of acrylic acid and other acidic monomers. These can be acrylic acid/maleic acid copolymers which differ from the copolymers of the invention only in terms of the monomer content. It is also possible, however, to use other polymers, such as dispersions (acrylates, styrene-butadiene dispersions), epoxy resins, polyurethane resins or melamine/formaldehyde resins, for example.

The amount of such secondary polymers should generally not exceed 50% by weight, based on the amount of all polymers used. Preferably their amount is 0 to 30% by weight, more preferably 0 to 20% by weight and very preferably 0 to 10% by weight.

The binder formulations with the copolymers of the invention can be used for producing fiber webs. Examples of such materials comprise nonwoven webs of cellulose, cellulose acetate, esters and ethers of cellulose, cotton, hemp, sisal, jute, flax, coconut fibers or banana fibers, cork, animal fibers, such as wool or hairs, and, in particular, nonwoven webs of synthetic or inorganic fibers, such as aramid fibers, carbon fibers, polyacrylonitrile fibers, polyester fibers, PVC fibers or mineral fibers (glass wool and rock wool). The unbonded fiber webs (untreated fiber webs) are bonded, i.e., consolidated or mechanically reinforced, by the binder formulations of the invention that are used. Preference is given to mineral fiber webs and natural fiber webs.

For use as binders for fiber webs the formulations can in particular comprise the following additives: silicates, silicones, boron compounds, lubricants, and wetting agents.

The binder formulation is applied to the untreated fiber web by coating, spraying, impregnating or soaking. The amount applied is advantageously such that the weight ratio of untreated fiber web to the components of the binder formulation, without taking into account the solvent or solvents, is 25:1 to 1:1, preferably from 20:1 to 3:1.

Application of the binder formulation to the untreated fiber web is generally followed by drying preferably at 100° C. to 400° C., in particular 130° C. to 280° C., very preferably 130 to 230° C., for a period of preferably 10 seconds to 10 minutes, in particular of 10 seconds to 3 minutes.

The resultant fiber webs bonded using the copolymers of the invention have an increased flexural strength in the dry and wet state as compared with conventional carboxylate-containing binders. By virtue of the high COOH density the polymers adhere very well to the untreated webs. Because of the relatively low residual monomer content, a lower level of emissions occurs in the course of preparation and use of the webs, and the webs are lower in odor. The leaching loss during use in the wet state is lower, which gives the bonded webs a consistently high strength.

The bonded fiber webs, especially mineral fiber webs, are suitable for use as roofing membranes, as base materials for wallpapers, or as inliners or base material for floor coverings made, for example, from PVC. For use as roofing membranes the bonded fiber webs are generally coated with bitumen.

The binder formulations with the copolymers of the invention can additionally be used as binders for insulants made from the abovementioned fibers, particularly inorganic fibers such as mineral fibers (glass wool and rock wool). Fibers for insulants are produced industrially to a large extent by spinning melts of the corresponding raw mineral materials, as disclosed for example by EP-A 567 480. The predominant fraction of the mineral fibers or glass fibers used in the insulants has a diameter between 0.5 and 20 μm and a length between 0.5 and 10 cm.

In the context of this utility it is possible with advantage to use an aqueous solution. Examples of additional components in the binder formulation in the context of this application comprise hydrophobicizers such as silicone oils, for example, alkoxysilanes such as 3-aminopropyltriethoxysilane, for example, as a coupling agent, soluble or emulsifiable oils as lubricants and dust binders, and also wetting assistants.

The aqueous formulation is preferably applied in the course of the production of the insulants by spraying directly onto the freshly produced fibers while they are still hot. The water predominantly evaporates and the binder formulation remains, in substantially uncured form, adhering as a viscous “high-solid” material to the fibers. These binder-containing fiber mats are transported by means of appropriate conveyor belts through a curing oven. There the resin cures at oven temperatures of about 150 to 350° C. After the curing oven the insulant mats are appropriately end-use-processed, i.e., cut to a shape suitable for the ultimate user.

The binder formulations are also suitable for producing abrasive pads, examples being pan cleaners or scourers based on bonded fiber webs. Fibers used for this application include, in particular, natural fibers and synthetic fibers, such as polyamides, for example. In the case of the pan cleaners or scourers the fiber webs are consolidated preferably by a spraying method.

The binder formulations are also suitable for producing woodbase materials such as chipboard and fiberboard, which can be produced by gluing disintegrated wood such as wood chips and wood fibers, for example (cf. Ullmanns Encyclopädie der technischen Chemie, 4th edition, 1976, volume 12, pp. 709-727).

The water resistance of woodbase materials can be enhanced by adding to the binder formulations a commercially customary aqueous paraffin dispersion or other hydrophobicizers, or adding such hydrophobicizers beforehand or afterward to the fibers, chips or shavings.

Chipboard production is known in principle and is described for example in H. J. Deppe, K. Ernst Taschenbuch der Spanplattentechnik, 2nd edition, Verlag Leinfelden 1982. Further details of the production are also disclosed in WO 97/31059, page 13 line 29 to page 14 line 27.

The binder formulations are additionally suitable for producing plywood and carpentry board according to the commonly known production processes.

Other natural fiber materials as well, such as sisal, jute, hemp, flax, kenaf, coconut fibers, banana fibers and other natural fibers, can be processed with the binder formulations comprising the copolymers of the invention to form boards and moldings. The natural fiber materials can also be used in mixtures with synthetic fibers, such as polypropylene, polyethylene, polyesters, polyamides or polyacrylonitrile. These synthetic fibers may in this case also function as cobinders alongside the copolymers of the invention. The fraction of the synthetic fibers is preferably less than 50%, in particular less than 30% and very preferably less than 10% by weight, based on all chips, shavings or fibers. The fibers can be processed by the method employed for wood fiberboard. Alternatively, preformed natural fiber mats can be impregnated with the formulations, with or without the addition of a wetting assistant. The impregnated mats are then compressed, in the binder-moist or pre-dried state, at temperatures between 100 and 250° C. and pressures between 10 and 100 bar, for example, to form boards or shaped parts.

A further application of the copolymers of the invention is their use in the manufacture of abrasive materials, particularly abrasive paper, woven abrasive cloth, abrasive pads or other abrasive articles. In this context customary abrasive grits are employed, based for example on corundum, quartz, garnet, pumice, tripel, silicon carbide, emery, aluminas, zirconias, kieselguhr, sand, gypsum, boron carbide, borides, carbides, nitrides, cerium oxide or silicates. The abrasive materials can be manufactured, for example, by first applying an aqueous formulation of the binder to the appropriate support, then adding the selected abrasive grit and, finally, further quantities of the aqueous polymer solution, modified if appropriate with, for example, dispersions as what is called a size coat.

A further inventive use of the copolymers is for producing filter materials, especially filter paper or filter cloth. Woven cloth materials may include, for example, cellulose, cotton, polyesters, polyamide, PE, PP, glass webs, and glass wool. The application of the binder formulation for use in accordance with the invention to the filter materials, i.e., to filter paper or filter cloth, inter alia, takes place preferably by impregnating or spraying. It is advisable subsequently to heat, i.e. to cure, these materials for 0.1 to 60 minutes, in particular 1 to 60 minutes, at temperatures of 100 to 250° C., in particular of 110 to 220° C.

A further inventive use of the copolymers is as binders for cork: cork webs, cork mats, cork blocks or cork boards, for example.

The examples which follow are intended to illustrate the invention in more detail:

### Measurement Methods:

The K values were measured by the method of H. Fikentscher, Cellulose-Chemie, vol. 13, pp. 58-64 and 71-74 (1932) in 1% strength by weight aqueous solution at 25° C. M_{w} values were determined by means of gel permeation chromatography.

### Part A: Preparation of the Inventive Copolymers

### A1) Polymers for Corrosion Protection

### EXAMPLE 1

In a stirred vessel with blade stirrer and internal thermometer 121.6 g of maleic anhydride are dissolved in 190 g of deionized water and the solution is stirred under gentle reflux and under nitrogen for one hour. 5.62 mg of iron(II) sulfate heptahydrate are added in one portion and feedstream 1, consisting of 86.2 g of triethanolamine in 50.0 g of deionized water, is metered in over 5 minutes. This corresponds to an equivalent degree of neutralization of 6.8 mol %. Subsequently feedstream 2, consisting of 431.3 g of acrylic acid in 336.0 g of deionized water, over 4 h, and feedstream 3, consisting of 57.6 g of hydrogen peroxide (30% strength) and 112.0 g of deionized water, over 5 h, are added. After the end of the addition stirring is continued under reflux conditions for 2 h and the solution is cooled to room temperature.

This gives a pale yellowish, clear polymer solution having a solids content of 44.8%, a K value of and a residual maleic acid content (based on the solid copolymer obtained) of 0.27%.

The experimental conditions and the results obtained are summarized in table 1.

### EXAMPLES 2 TO 9, COMPARATIVE EXAMPLES 1 TO 5

Using the same procedure as in example 1, copolymers were prepared by varying the amount of type and amount of base and by altering the amounts and type of the monomers. The experimental conditions and the results obtained are summarized in table 1.

### EXAMPLE 10

In a 160 l capacity tank with blade stirrer and internal thermometer, 8.067 kg of maleic anhydride and 4.007 kg of vinylphosphonic acid (95% strength) are dissolved in 12 kg of deionized water and the solution is stirred under gentle reflux for an hour, accompanied by nitrogen gassing. 46.639 g of iron(II) sulfate heptahydrate in 1.49 kg of deionized water are added in one portion and feedstream 1, consisting of 5.732 kg of triethanolamine in 5.0 kg of deionized water, is metered in over 5 minutes. This corresponds to an equivalent degree of neutralization (based on total COOH) of 6.8 mol %. Subsequently feedstream 2, consisting of 28.607 kg of acrylic acid, over 5 h, and feedstream 3, consisting of 2.455 kg of sodium peroxodisulfate and 32.6 kg of deionized water, over 6 h, are added. After the end of the addition, feedstream 2 is flushed into the tank with 5 kg of deionized water, stirring is continued for 2 h under reflux conditions, and the solution is cooled to room temperature.

This gives a clear polymer solution having a solids content of 46.2%, a K value of 19.7 and a residual maleic acid content (based on the solid copolymer obtained) of 0.98%.

The experimental conditions and the results obtained are summarized in table 1.

### EXAMPLE 11

In a 160 l capacity tank with blade stirrer and internal thermometer, 7.161 kg of maleic anhydride and 8.951 kg of vinylphosphonic acid (95% strength) are dissolved in 12 kg of deionized water and the solution is stirred under gentle reflux for an hour, accompanied by nitrogen gassing. 41.4 g of iron(II) sulfate heptahydrate in 740 g of deionized water are added in one portion and feedstream 1, consisting of 5.088 kg of triethanolamine in 5.0 kg of deionized water, is metered in over 5 minutes. This corresponds to an equivalent degree of neutralization (based on total COOH) of 6.8 mol %. Subsequently feedstream 2, consisting of 25.322 kg of acrylic acid, over 5 h, and feedstream 3, consisting of 2.497 kg of sodium peroxodisulfate and 33.2 kg of deionized water, over 6 h, are added. After the end of the addition, feedstream 2 is flushed into the tank with 5 kg of deionized water, stirring is continued for 2 h under reflux conditions, and the solution is cooled to room temperature.

This gives a clear polymer solution having a solids content of 46.4%, a K value of 18.4 and a residual maleic acid content (based on the solid copolymer obtained) of 2.18%.

The experimental conditions and the results obtained are summarized in table 1.

### A2) Polymers for Fiber Binding

### EXAMPLE 12

In a reactor with stirrer, nitrogen feed, reflux condenser and metering apparatus 336.9 g of distilled water, 6.7 mg of FeSO₄×7H₂O and 150.4 g of maleic anhydride were heated with stirring to an internal temperature of 80° C. under nitrogen. Then 218.6 g of triethanolamine were metered in continuously over the course of 15 minutes, during which the internal temperature was raised to 99° C. Then continuously in two separate feeds a mixture of 550.5 g of acrylic acid and 383.0 g of distilled water was added over 4 h and a mixture of 36.46 g of a 30% strength by weight aqueous hydrogen peroxide solution and 42.82 g of distilled water was added over 5 h. After subsequent stirring for two hours at 99° C. the product was cooled.

For use for fiber binding, 175.6 g of distilled water were added. This gave a polymer solution having a solids content of 49.4% by weight, a pH of 3.12 and a K value of 35.6.

The data are compiled in table 2.

### EXAMPLE 13

In the apparatus of example 12267.6 g of distilled water, 6.7 mg of FeSO₄×7H₂O and 171.1 g of maleic anhydride were heated with stirring to an internal temperature of 80° C. under nitrogen. Then 202.5 g of triethanolamine are metered in continuously over the course of 15 minutes, during which the internal temperature is raised to 99° C. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 g of distilled water was added over 5 h. After subsequent stirring for two hours at 99° C. the product was cooled.

For use for fiber binding, 202.5 g of distilled water were added. This gave a polymer solution having a solids content of 49.4% by weight, a pH of 3.04 and a K value of 25.5.

### EXAMPLE 14

In the apparatus of example 12267.6 g of distilled water, 6.7 mg of FeSO₄×7H₂O and 171.1 g of maleic anhydride were heated with stirring to an internal temperature of 80° C. under nitrogen. Then 135.0 g of triethanolamine are metered in continuously over the course of 15 minutes, during which the internal temperature is raised to 99° C. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 g of distilled water was added over 5 h. After subsequent stirring for two hours at 99° C. the product was cooled.

For use for fiber binding, a mixture of 202.5 g of distilled water and 67.5 g of triethanolamine as crosslinker was added. This gave a polymer solution having a solids content of 49.3% by weight, a pH of 3.10 and a K value of 26.1.

### EXAMPLE 15

In the apparatus of example 12267.6 g of distilled water, 6.7 mg of FeSO₄×7H₂O and 171.1 g of maleic anhydride were heated with stirring to an internal temperature of 80° C. under nitrogen. Then 67.5 g of triethanolamine are metered in continuously over the course of 15 minutes, during which the internal temperature is raised to 99° C. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 g of distilled water was added over 5 h. After subsequent stirring for two hours at 99° C. the product was cooled.

For use for fiber binding, a mixture of 202.5 g of distilled water and 135.0 g of triethanolamine as crosslinker was added. This gave a polymer solution having a solids content of 49.4% by weight, a pH of 3.06 and a K value of 28.7.

### EXAMPLE 16

In the apparatus of example 12267.6 g of distilled water, 6.7 mg of FeSO₄×7H₂O and 171.1 g of maleic anhydride were heated with stirring to an internal temperature of 80° C. under nitrogen. Then 50.6 g of triethanolamine are metered in continuously over the course of 15 minutes, during which the internal temperature is raised to 99° C. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 g of distilled water was added over 5 h. After subsequent stirring for two hours at 99° C. the product was cooled.

For use for fiber binding, a mixture of 202.5 g of distilled water and 151.9 g of triethanolamine as crosslinker was added. This gave a polymer solution having a solids content of 49.1% by weight, a pH of 3.03 and a K value of 30.8.

### EXAMPLE 17

In the apparatus of example 12267.6 g of distilled water, 6.7 mg of FeSO₄×7H₂O and 228.1 g of maleic anhydride were heated with stirring to an internal temperature of 80° C. under nitrogen. Then 202.5 g of triethanolamine are metered in continuously over the course of 15 minutes, during which the internal temperature is raised to 99° C. Then continuously in two separate feeds a mixture of 405.0 g of acrylic acid and 236.4 g of distilled water was added over 4 h and a mixture of 67.5 g of a 30% strength by weight aqueous hydrogen peroxide solution and 135.0 g of distilled water was added over 5 h. After subsequent stirring for two hours at 99° C. the product was cooled.

For use for fiber binding, 202.5 g of distilled water were added. This gave a polymer solution having a solids content of 49.1% by weight, a pH of 2.95 and a K value of 18.6.

### EXAMPLE 18

In the apparatus of example 12237.0 g of distilled water, 6.7 mg of FeSO₄×7H₂O and 276.9 g of maleic anhydride were heated with stirring to an internal temperature of 80° C. under nitrogen. Then 199.5 g of triethanolamine are metered in continuously over the course of 15 minutes, during which the internal temperature is raised to 99° C. Then continuously in two separate feeds a mixture of 335.4 g of acrylic acid and 236.7 g of distilled water was added over 4.5 h and 154.7 g of a 30% strength by weight aqueous hydrogen peroxide solution were added over 6 h. After subsequent stirring for two hours at 99° C. the product was cooled.

For use for fiber binding, 284.9 g of distilled water were added. This gave a polymer solution having a solids content of 48.2% by weight, a pH of 2.80 and a K value of 14.3.

### EXAMPLE 19

In the apparatus of example 12237.0 g of distilled water, 6.7 mg of FeSO₄×7H₂O and 276.9 g of maleic anhydride were heated with stirring to an internal temperature of 80° C. under nitrogen. Then 99.8 g of triethanolamine are metered in continuously over the course of 15 minutes, during which the internal temperature is raised to 99° C. Then in two separate feeds a mixture of 335.4 g of acrylic acid and 236.7 g of distilled water was added over 4.5 h and 154.7 g of a 30% strength by weight aqueous hydrogen peroxide solution were added over 6 h. After subsequent stirring for two hours at 99° C. the product was cooled.

For use for fiber binding, a mixture of 284.9 g of distilled water and 99.8 g of triethanolamine as crosslinker was added. This gave a polymer solution having a solids content of 48.1% by weight, a pH of 2.80 and a K value of 14.1.

### EXAMPLE 20

In the apparatus of example 12237.0 g of distilled water, 6.7 mg of FeSO₄×7H₂O and 276.9 g of maleic anhydride were heated with stirring to an internal temperature of 80° C. under nitrogen. Then 49.9 g of triethanolamine are metered in continuously over the course of 15 minutes, during which the internal temperature is raised to 99° C. Then in two separate feeds a mixture of 335.4 g of acrylic acid and 236.7 g of distilled water was added over 4.5 h and 154.7 g of a 30% strength by weight aqueous hydrogen peroxide solution were added over 6 h. After subsequent stirring for two hours at 99° C. the product was cooled.

For use for fiber binding, a mixture of 284.9 g of distilled water and 149.6 g of triethanolamine as crosslinker was added. This gave a polymer solution having a solids content of 48.0% by weight, a pH of 2.80 and a K value of 15.6.

### COMPARATIVE EXAMPLE 6

### No Base During the Polymerization

In a pressure reactor with stirrer, nitrogen feed and metering apparatus 336.9 g of distilled water, 6.7 mg of FeSO₄×7H₂O and 150.4 g of maleic anhydride were heated with stirring to an internal temperature of 110° C. under nitrogen. Then continuously in two separate feeds a mixture of 550.5 g of acrylic acid and 383.0 g of distilled water was added over 4 h and a mixture of 36.46 g of a 30% strength by weight aqueous hydrogen peroxide solution and 42.82 g of distilled water was added over 5 h. After subsequent stirring for two hours at 110° C. the product was cooled.

For use for fiber binding, 175.6 g of distilled water and 218.6 g of triethanolamine as crosslinker were added. This gave a polymer solution having a solids content of 49.6% by weight, a pH of 3.01 and a K value of 30.6.

### COMPARATIVE EXAMPLE 7

### No Base During the Polymerization

In a reactor with stirrer, nitrogen feed, reflux condenser and metering apparatus 267.6 g of distilled water, 6.7 mg of FeSO₄×7H₂O and 171.1 g of maleic anhydride were heated with stirring to an internal temperature of 99° C. under nitrogen. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 of distilled water was added over 5 h. After subsequent stirring for two hours at 99° C. the product was cooled.

For use for fiber binding, a mixture of 202.5 g of distilled water and 202.5 g of triethanolamine as crosslinker was added. This gave a polymer solution having a solids content of 49.2% by weight, a pH of 2.83 and a K value of 28.4.

### COMPARATIVE EXAMPLE 8

### No Base During the Polymerization

In a pressure reactor with stirrer, nitrogen feed and metering apparatus 267.6 g of distilled water, 6.7 mg of FeSO₄×7H₂O and 171.1 g of maleic anhydride were heated with stirring to an internal temperature of 135° C. under nitrogen. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 of distilled water was added over 5 h. After subsequent stirring for two hours at 135° C. the product was cooled.

For use for fiber binding, a mixture of 202.5 g of distilled water and 202.5 g of triethanolamine as crosslinker was added. This gave a polymer solution having a solids content of 48.2% by weight, a pH of 2.67 and a K value of 15.0.

### COMPARATIVE EXAMPLE 9

### No Base During the Polymerization

In a reactor with stirrer, nitrogen feed, reflux condenser and metering apparatus 237.0 g of distilled water, 6.7 mg of FeSO₄×7H₂O and 276.9 g of maleic anhydride were heated with stirring to an internal temperature of 99° C. under nitrogen. Then continuously in two separate feeds a mixture of 335.4 g of acrylic acid and 236.7 g of distilled water was added over 4.5 h and 154.7 g of a 30% strength by weight aqueous hydrogen peroxide solution were added over 6 h. After subsequent stirring for two hours at 99° C. the product was cooled.

For use for fiber binding, a mixture of 284.9 g of distilled water and 199.5 g of triethanolamine as crosslinker was added. This gave a polymer solution having a solids content of 47.1% by weight, a pH of 2.20 and a K value of 13.8.

### COMPARATIVE EXAMPLE 10

### No Base During the Polymerization

In a pressure reactor with stirrer, nitrogen feed and metering apparatus 237.0 g of distilled water, 6.7 mg of FeSO₄×7H₂O and 276.9 g of maleic anhydride were heated with stirring to an internal temperature of 130° C. under nitrogen. Then continuously in two separate feeds a mixture of 335.4 g of acrylic acid and 236.7 g of distilled water was added over 4.5 h and 154.7 g of a 30% strength by weight aqueous hydrogen peroxide solution were added over 6 h. After subsequent stirring for two hours at 130° C. the product was cooled.

For use for fiber binding, a mixture of 284.9 g of distilled water and 199.5 g of triethanolamine as crosslinker was added. This gave a polymer solution having a solids content of 47.3% by weight, a pH of 2.18 and a K value of 10.8.

### COMPARATIVE EXAMPLE 11

Water, 6.7 mg of FeSO₄×7H₂O and 171.1 g of maleic anhydride were heated with stirring to an internal temperature of 80° C. under nitrogen. Then 202.5 g of triethanolamine are metered in continuously over the course of 15 minutes, during which the internal temperature is raised to 99° C. Then continuously in two separate feeds a mixture of 472.5 g of acrylic acid and 236.4 g of distilled water was added over 4 h and a mixture of 67.5 g of a 30% strength by weight aqueous hydrogen peroxide solution and 135.0 g of distilled water was added over 5 h. After subsequent stirring for two hours at 99° C. the product was cooled.

For use for fiber binding, 202.5 g of distilled water were added. This gave a polymer solution having a solids content of 49.4% by weight, a pH of 3.06 and a K value of 25.6. Subsequently 297.6 g of triethanolamine and 270.0 g of distilled water were added (pH: 4.3).

### COMPARATIVE EXAMPLE 12

### Base NaOH

In a pressure reactor with stirrer, nitrogen feed and metering apparatus 439.0 g of distilled water, 6.7 mg of FeSO₄×7H₂O and 154.7 g of maleic anhydride were introduced under nitrogen and with stirring, then 230.5 g of sodium hydroxide solution (50% by weight) were metered in, after which the internal temperature was raised to 115° C. Then continuously in two separate feeds a mixture of 468.4 g of acrylic acid and 311.1 g of distilled water was added over 3.5 h and 27.5 g of a 50% strength by weight aqueous hydrogen peroxide solution were added over 3.5 h. Following the addition of a further 9.2 g of a 50% strength by weight aqueous hydrogen peroxide solution over the course of 1.0 h at 115° C. the batch was cooled to 80° C. and 397.7 g of 50% strength by weight sodium hydroxide solution were added over the course of 2 h.

This gave a polymer solution having a solids content of 41.2% by weight, a pH of 7.7 and a K value of 60.2. 195.2 g of triethanolamine were added as crosslinker.

### Part B: Performance Testing of the Inventive Polymers

### B1) Use for Corrosion Protection

For the inventive and comparative examples test panels made of galvanized steel (20 μm zinc add-on on one side) were used, specifically an alkalinically galvanized sheet and a hot-dip-galvanized sheet in each case.

In the examples the metal sheets were pretreated as follows:

unpassivated alkalinically galvanized steel sheets were immersed for 10 s in a cleaning solution composed of 0.5% of HCl and 0.1% of an alkylphenol ethoxylate having 10 ethylene oxide units, rinsed off immediately with water and then dried by blowing. Unpassivated hot-dip-galvanized steel sheets are immersed in an alkaline degreaser for 120 seconds at 50° C., rinsed immediately with deionized water and dried by blowing.

Preparation of the compositions for passivating:

5% strength aqueous solutions of each of the polymers used were homogenized and introduced into a dipping bath. The precleaned metal sheets were immersed into the solution, which was conditioned at 50° C., for 30 s and dried at room temperature. Finally the edges of the passivated sheets were masked, in order to rule out edge effects.

The metal sheets were passivated as described below.

The thickness of the passivating layer was determined by differential weighing before and after the metal surface had been exposed to the composition used in accordance with the invention, on the assumption that the layer has a specific density of 1 kg/l. Below by “layer thickness” is meant in each case a parameter determined in this way, irrespective of the actual specific density of the layer.

One batch of the metal sheets is painted with a commercially customary paint. The painted sheets are tested for paint adhesion using the cross-cut test according to DIN EN ISO 2409. The paint adhesion corresponds to the adhesion to phosphatized metal sheets and is better than that of unpassivated sheets. After the paint has dried it is scored down to the metal and exposed to a salt spray test according to DIN 50021. The comparison with nonpassivated sheets and with phosphatized sheets shows that the passivation of the invention reduces the subfilm migration by more than 50%.

The degree of corrosion was assessed on the basis of the appearance of the metal sheets. For this purpose the appearance of the treated metal sheets was compared with the standard damage pictures in DIN 50021, in each case after 28 h and after 50 h in the salt spray test, and a rating from 10 to 1 was given in accordance with the evaluation specified by the standard. 10 here is the best result, while as the evaluation goes down the extent of corrosion increases. 1 stands for the poorest result.

The results of the inventive and comparative experiments are summarized in table 3.

### B2) Use for Binding Glass Fiber Webs

### Preparation of the Formulations:

For the performance experiments the copolymer solutions obtained in inventive examples 8 to 16 and comparative examples 6 to 12 were each adjusted to a concentration of 49%-50% by weight solids content, as already described therein, using distilled water, and if appropriate additional triethanolamine was added as crosslinker, so that the total amount of triethanolamine in the solution was in each case 30% by weight, based on the polymer. Triethanolamine already used in the course of the polymerization was taken into account. In addition approximately 1% by weight of γ-aminopropyltriethoxysilane, based on the sum of all components apart from the solvent, was stirred into the solution.

The pH values of the formulations are given in table 3.

### Treatment of the Webs:

An untreated glass fiber web (approximately 50 g/m²) was used with a length of 32 cm and a width of 28 cm.

The webs are guided in the longitudinal direction over a continuous PES screen belt first through a 20% binder liquor and subsequently via a suction apparatus. The belt speed is 0.6 m/min. The wet add-on is controlled by the adjustable strength of the suction. In the case of a wet add-on of approximately 100% the dry-add on, with a binder liquor concentration of 20%, is 20%+/−2%.

The impregnated webs are cured at 180° C. for 2 minutes on a PES net support in a Mathis dryer.

Test of flexural rigidity:

Preparation of the test specimens:

6 test specimens for testing the flexural rigidity in the longitudinal direction are cut from the web. The size of the webs for the flexural rigidity test is 70×30 mm.

### Test Procedure:

The test strip is fixed in a clamping means and bent at an angle of 20° at a distance of 10 mm by way of a holder. The height of the test strip is 30 mm. The force measured represents the flexural rigidity. A total of 6 test specimens are measured, from the facing side and reverse side respectively, and a mean value is determined.

The results of the tests are represented in table 4.

TABLE 1
Experimental conditions and results of the inventive and comparative examples;

| | | | Further comonomers | | | | | | |
|---|---|---|---|---|---|---|---|---|---|
| | | MA | | Amount | Base added | Equivalent degree of | | Residual maleic | |
| | AA [% by | [% by | | [% by | during the | neutralization during | T | acid content | |
| No. | weight] | weight] | Type | weight] | polymerization | polymerization [mol %] | [° C.] | [% by weight] | K value |
| Example 1 | 75 | 25 | — | — | TEA | 6.8 | 98 | 0.3 | 30.8 |
| Example 2 | 75 | 25 | — | — | DEA | 6.8 | 98 | 0.7 | 26.5 |
| Example 3 | 75 | 25 | — | — | EA | 6.8 | 98 | 0.7 | 43.8 |
| Example 4 | 75 | 25 | — | — | TEA | 3.4 | 98 | 2.0 | 32.4 |
| Example 5 | 65 | 35 | — | — | TEA | 6.8 | 98 | 1.1 | 21.2 |
| Example 6 | 71 | 24 | hydroxyethyl acrylate | 5 | TEA | 6.8 | 98 | 0.3 | 44.4 |
| Example 7 | 71 | 24 | vinylphosphonic acid | 5 | TEA | 6.4 | 98 | 1.3 | 41.2 |
| Example 8 | 68 | 23 | vinylphosphonic acid | 9 | TEA | 6.8 | 99 | 0.05 | 18.0 |
| Example 9 | 59.86 | 20.04 | vinylphosphonic acid | 20.1 | DMEA | 6.8 | 99 | 0.61 | 17.5 |
| Example 10 | 68 | 23 | vinylphosphonic acid | 9 | TEA | 6.8 | 99 | 0.98 | 19.7 |
| Example 11 | 59.86 | 20.04 | vinylphosphonic acid | 20.1 | TEA | 6.9 | 99 | 2.18 | 18.4 |
| Comparative | 75 | 25 | — | — | — | 0 | 98 | 16.7 | 26.5 |
| example 1 | | | | | | | | | |
| Comparative | 75 | 25 | — | — | TEA | 2 | 98 | 8.1 | 29.2 |
| example 2 | | | | | | | | | |
| Comparative | 75 | 25 | — | — | TEA | 60 | 98 | 8.4 | 29.1 |
| example 3 | | | | | | | | | |
| Comparative | 75 | 25 | — | — | NaOH | 6.8 | 98 | 1.0 | 42.7 |
| example 4 | | | | | | | | | |
| Comparative | 75 | 25 | — | — | NH₃ | 6.8 | 98 | 1.2 | 43.8 |
| example 5 | | | | | | | | | |

key to abbreviations:
AA: acrylic acid;
MA: maleic acid,
EA: ethanolamine,
DEA: diethanolamine,
TEA: triethanolamine

TABLE 2
Experimental conditions and results of the inventive and comparative examples

| | | | | Equivalent degree of | | Residual | | |
|---|---|---|---|---|---|---|---|---|
| | AA | MA | Base added | neutralization during | | maleic acid | | |
| | [% by | [% by | during the | polymerization | T | content | | M_{w} |
| No. | weight] | weight] | polymerization | [mol %] | [° C.] | [% by weight] | K value | [g/mol] |
| Example 12 | 75 | 25 | TEA | 13 | 99 | 0.1 | 35.6 | 100 000 |
| Example 13 | 70 | 30 | TEA | 12.7 | 99 | <0.1 | 25.5 | n.d. |
| Example 14 | 70 | 30 | TEA | 8.5 | 99 | <0.1 | 26.1 | 44 000 |
| Example 15 | 70 | 30 | TEA | 4.2 | 99 | 0.5 | 28.7 | n.d. |
| Example 16 | 70 | 30 | TEA | 3.2 | 99 | 1.3 | 30.8 | 72 000 |
| Example 17 | 60 | 40 | TEA | 12.2 | 99 | 0.43 | 18.6 | 15 000 |
| Example 18 | 50 | 50 | TEA | 11.7 | 99 | 1.8 | 14.3 | 8000 |
| Example 19 | 50 | 50 | TEA | 5.5 | 99 | 1.0 | 14.1 | n.d. |
| Example 20 | 50 | 50 | TEA | 2.9 | 99 | 3.8 | 15.6 | n.d. |
| Comparative example 6 | 75 | 25 | — | — | 110 | 4.1 | 30.6 | 93 000 |
| Comparative example 7 | 70 | 30 | — | 0 | 99 | 9.8 | 28.4 | n.d. |
| Comparative example 8 | 70 | 30 | — | 0 | 135 | 1.8 | 15 | 12 000 |
| Comparative example 9 | 50 | 50 | — | 0 | 99 | 15.9 | 13.8 | n.d. |
| Comparative example 10 | 50 | 50 | — | 0 | 130 | 1.2 | 10.8 | 3000 |
| Comparative example 11 | 70 | 30 | TEA | 13.8 | 99 | 0.05 | 25.6 | n.d. |
| Comparative example 12 | 70 | 30 | NaOH | 29.8 | 115 | 0.05 | 60.2 | 70000 |

(n.d.: not determined)

TABLE 3
Results of the corrosion protection investigations

| | | | | | | | Salt spray test | | | | | |
|---|---|---|---|---|---|---|---|---|---|---|---|---|
| | | | Further comonomers | | | Equivalent | Akalinically galvanized | | | Hot-dip-galvanized | | |
| | | | | Amount | | degree of | sheet | | | sheet | | |
| Copolymer | AA [% by | MA [% by | | [% by | | neutralization | Layer | | | Layer | | |
| employed No. | weight] | weight] | Type | weight] | Base | [mol %] | thickness | 28 h | 50 h | thickness | 28 h | 50 h |
| Example 1 | 75 | 25 | — | — | TEA | 6.8 | 2.2 | 9 | 7 | 1.6 | 3 | 1 |
| Example 2 | 75 | 25 | — | — | DEA | 6.8 | 1.3 | 3 | 1 | 1.0 | 7 | 1 |
| Example 3 | 75 | 25 | — | — | EA | 6.8 | 1.4 | 8 | 6 | 1.0 | 2 | 1 |
| Example 5 | 65 | 35 | — | — | TEA | 6.8 | 1.4 | 7 | 4 | 1.3 | 4 | 1 |
| Example 6 | 71 | 24 | hydroxyethyl | 5 | TEA | 6.8 | 2.3 | 6 | 2 | 1.7 | 5 | 2 |
| | | | acrylate | | | | | | | | | |
| Example 7 | 71 | 24 | vinylphosphonic | 5 | TEA | 6.4 | 2.2 | 8 | 7 | 2.2 | 5 | 1 |
| | | | acid | | | | | | | | | |
| Example 8 | 68 | 23 | vinylphosphonic | 9 | TEA | 9 | — | — | — | 1 | 10 | 1 |
| | | | acid | | | | | | | | | |
| Example 9 | 59.9 | 20.0 | vinylphosphonic | 20.1 | DMEA | 20.1 | — | — | — | 1 | 10 | 8 |
| | | | acid | | | | | | | | | |
| Example 10 | 68 | 23 | vinylphosphonic | 9 | TEA | 9 | — | — | — | 1 | 8 | 1 |
| | | | acid | | | | | | | | | |
| Example 11 | 59.9 | 20.0 | vinylphosphonic | 20.1 | TEA | 20.1 | — | — | — | 1 | 10 | >8 |
| | | | acid | | | | | | | | | |
| Comparative | 75 | 25 | — | — | TEA | 60 | 5.4 | 1 | 1 | 1.3 | 1 | 1 |
| example 3 | | | | | | | | | | | | |
| Comparative | 75 | 25 | — | — | NaOH | 6.8 | 1.9 | 7 | 1 | 0.7 | 1 | 1 |
| example 4 | | | | | | | | | | | | |

TABLE 4
Formulations used and results of fiber binding.

| | | | Equivalent degree | | | | |
|---|---|---|---|---|---|---|---|
| | | | of neutralization in | Equivalent degree | | | |
| Copolymer | AA | MA | the course of the | of neutralization of | | Flexural | |
| employed | [% by | [% by | polymerization | the formulation | | rigidity | |
| No. | weight] | weight] | [mol %] | [mol %] | pH | [mN] | Remarks |
| Example 12 | 75 | 25 | 13 | 13 | 3.1 | 320 | |
| Example 13 | 70 | 30 | 12.7 | 13 | 3.0 | 325 | |
| Example 14 | 70 | 30 | 8.5 | 13 | 3.1 | 340 | |
| Example 15 | 70 | 30 | 4.2 | 13 | 3.1 | 336 | |
| Example 16 | 70 | 30 | 3.2 | 13 | 3.0 | 329 | |
| — | — | — | — | — | — | 113 | Untreated web |
| | | | | | | | without polymer |
| Comparative example 6 | 75 | 25 | 0 | 13 | 3.0 | 303 | |
| Comparative example 7 | 70 | 30 | 0 | 13 | 2.8 | 258 | |
| Comparative example 8 | 70 | 30 | 0 | 13 | 2.7 | 290 | |
| Comparative example 11 | 70 | 30 | 13.8 | 33.3 | 4.3 | 294 | Excessive |
| | | | | | | | crosslinker |
| Comparative example 12 | 70 | 30 | 29.8 | 95 | 7.7 | 108 | NaOH as base in |
| | | | | | | | the course of the |
| | | | | | | | polymerization |

The inventive and comparative examples show that by means of the process of the invention carboxylate-rich copolymers are obtained from monoethylenically unsaturated monocarboxylic acids and at least 20.1% of monoethylenically unsaturated dicarboxylic acids, these copolymers having a low residual unpolymerized dicarboxylic acid content despite a low degree of neutralization. It is possible to obtain copolymers having a very high fraction of dicarboxylic acids but still having a comparatively high molecular weight. The amines used in accordance with the invention are much more effective at low degrees of neutralization than are sodium hydroxide solution or ammonia.

Performance experiments with the copolymers obtained in accordance with the invention show that the copolymers have much better performance properties.

Passivating layers obtained using the polymers of the invention have a considerably better corrosion protection effect than customary copolymers with a higher degree of neutralization.

Binder formulations prepared by means of the copolymers of the invention and used for fiber binding reinforce webs much better than customary copolymers having a relatively high degree of neutralization.

1-31. (canceled)

32. A process for preparing a carboxylate-rich copolymer, the process comprising:
(i) providing monomers (A), (B) and (C); and
(ii) subjecting the monomers (A), (B) and (C) to free-radical polymerization in an aqueous solution;
wherein monomer (A) comprises at least one monoethylenically unsaturated monocarboxylic acid, and is present in an amount of 30% to 79.99% by weight based on a total weight of the monomers;
wherein monomer (B) comprises at least one monoethylenically unsaturated dicarboxylic acid selected from the group consisting of acids corresponding to general formula I, acids corresponding to general formula II, anhydrides thereof, and other hydrolyzable derivatives thereof, and is present in an amount of 20.01% to 70% by weight based on a total weight of the monomers:
(HOOC)R¹C═CR²(COOH) (I)
R¹R²C═C(—(CH₂)ₙ—COOH)(COOH) (II)
wherein R¹ and R² each independently represent H or a straight-chain or branched, optionally substituted alkyl radical having 1 to 20 carbon atoms, or, in the case of (I), R¹ and R² together being an optionally substituted alkylene radical having 3 to 20 carbon atoms, and n represents an integer from 0 to 5;
wherein monomer (C) comprises at least one additional ethylenically unsaturated comonomer, and is present in an amount of 0% to 40% by weight based on a total weight of the monomers;
wherein the polymerization is carried out at a temperature of less than 130° C. in the presence of 2 to 18 mol % of at least one amine, based on the total amount of all COOH groups of the monocarboxylic and dicarboxylic acids; and wherein the carboxylate-rich copolymer has an average molecular weight M_{w} of at least 3000 g/mol.

33. The process according to claim 32, wherein the polymerization is carried out in the presence of 3 to 16 mol % of at least one amine, based on the total amount of all COOH groups of the monocarboxylic and dicarboxylic acids.

34. The process according to claim 32, wherein R¹ and R² each independently represent hydrogen or a methyl group.

35. The process according to claim 33, wherein R¹ and R² each independently represent hydrogen or a methyl group.

36. The process according to claim 32, wherein monomer (B) comprises at least one monoethylenically unsaturated dicarboxylic acid selected from the group consisting of maleic acid and maleic anhydride.

37. The process according to claim 35, wherein monomer (B) comprises at least one monoethylenically unsaturated dicarboxylic acid selected from the group consisting of maleic acid and maleic anhydride.

38. The process according to claim 32, wherein monomer (A) comprises (meth)acrylic acid.

39. The process according to claim 36, wherein monomer (A) comprises (meth)acrylic acid.

40. The process according to claim 32, wherein the polymerization is carried out in the presence of at least one amine selected from the group consisting of monoethanolamine, diethanolamine, triethanolamine and ethoxylates thereof.

41. The process according to claim 39, wherein the polymerization is carried out in the presence of at least one amine selected from the group consisting of monoethanolamine, diethanolamine, triethanolamine and ethoxylates thereof.

42. The process according to claim 32, wherein the polymerization is carried out at a temperature of 80° C. to 130° C.

43. The process according to claim 32, wherein monomer (C) comprises at least one additional ethylenically unsaturated comonomer having one or more acid groups selected from the group consisting of phosphonic acid, phosphoric acid and combinations thereof, and is present in an amount of 5% to 40% by weight based on a total weight of the monomers.

44. The process according to claim 39, wherein monomer (C) comprises at least one additional ethylenically unsaturated comonomer having one or more acid groups selected from the group consisting of phosphonic acid, phosphoric acid and combinations thereof, and is present in an amount of 5% to 40% by weight based on a total weight of the monomers.

45. A process for preparing a carboxylate-rich copolymer, the process comprising:
(i) providing monomers (A), (B) and (C); and
(ii) subjecting the monomers (A), (B) and (C) to free-radical polymerization in an aqueous solution;
wherein monomer (A) comprises (meth)acrylic acid, and is present in an amount of 30% to 79.99% by weight based on a total weight of the monomers;
wherein monomer (B) comprises at least one monoethylenically unsaturated dicarboxylic acid selected from the group consisting of maleic acid, maleic anhydride and combinations thereof, and is present in an amount of 22% to 60% by weight based on a total weight of the monomers;
wherein monomer (C) comprises at least one additional ethylenically unsaturated comonomer having one or more acid groups selected from the group consisting of phosphonic acid, phosphoric acid and combinations thereof, and is present in an amount of 5% to 40% by weight based on a total weight of the monomers;
wherein the polymerization is carried out at a temperature of less than 130° C. in the presence of 3 to 16 mol % of at least one amine selected from the group consisting of monoethanolamine, diethanolamine, triethanolamine and ethoxylates thereof, based on the total amount of all COOH groups of the monocarboxylic and dicarboxylic acids; and wherein the carboxylate-rich copolymer has an average molecular weight M_{w} of at least 5000 g/mol.

46. A partially neutralized, carboxylate-rich copolymer comprising monomers (A), (B), and (C);
wherein monomer (A) comprises at least one monoethylenically unsaturated monocarboxylic acid, and is present in an amount of 30% to 79.99% by weight;
wherein monomer (B) comprises at least one monoethylenically unsaturated dicarboxylic acid selected from the group consisting of acids corresponding to general formula I, acids corresponding to general formula II, anhydrides thereof, and other hydrolyzable derivatives thereof, and is present in an amount of 20.01% to 70% by weight:
(HOOC)R¹C═CR²(COOH) (I)
R¹R²C═C(—(CH₂)ₙ—COOH)(COOH) (II)
wherein R¹ and R² each independently represent H or a straight-chain or branched, optionally substituted alkyl radical having 1 to 20 carbon atoms, or, in the case of (I), R¹ and R² together being an optionally substituted alkylene radical having 3 to 20 carbon atoms, and n represents an integer from 0 to 5;
wherein monomer (C) comprises at least one additional ethylenically unsaturated comonomer, and is present in an amount of 0% to 40% by weight;
wherein the carboxylate-rich copolymer is partially neutralized with at least one amine and the carboxylate-rich copolymer has a degree of neutralization of 2 to 18 mol %, based on the total amount of all COOH groups of the monocarboxylic and dicarboxylic acids; and wherein the carboxylate-rich copolymer has an average molecular weight M_{w} of at least 3000 g/mol.

47. The carboxylate-rich copolymer according to claim 46, wherein the degree of neutralization of 3 to 16 mol %, based on the total amount of all COOH groups of the monocarboxylic and dicarboxylic acids.

48. The carboxylate-rich copolymer according to claim 46, wherein the at least one amine is selected from the group consisting of monoethanolamine, diethanolamine, triethanolamine and ethoxylates thereof.

49. The carboxylate-rich copolymer according to claim 46, wherein R¹ and R² each independently represent hydrogen or a methyl group.

50. The carboxylate-rich copolymer according to claim 47, wherein R¹ and R² each independently represent hydrogen or a methyl group.

51. The carboxylate-rich copolymer according to claim 46, wherein monomer (B) comprises at least one monoethylenically unsaturated dicarboxylic acid selected from the group consisting of maleic acid and maleic anhydride.

52. The carboxylate-rich copolymer according to claim 46, wherein monomer (B) is present in an amount of 22% to 60% by weight.

53. The carboxylate-rich copolymer according to claim 46, wherein monomer (A) comprises (meth)acrylic acid.

54. The carboxylate-rich copolymer according to claim 51, wherein monomer (A) comprises (meth)acrylic acid.

55. The carboxylate-rich copolymer according to claim 46, wherein monomer (C) comprises at least one additional ethylenically unsaturated comonomer having one or more acid groups selected from the group consisting of phosphonic acid, phosphoric acid and combinations thereof, and is present in an amount of 5% to 40% by weight based on a total weight of the monomers.

56. The carboxylate-rich copolymer according to claim 46, wherein monomer (C) comprises vinylphosphonic acid.

57. The carboxylate-rich copolymer according to claim 46, wherein the carboxylate-rich copolymer has an average molecular weight M_{w} of at least 5000 g/mol.

58. A method comprising:
(a) providing a metallic surface to be treated; and
(b) contacting the surface with a formulation comprising a partially neutralized, carboxylate-rich copolymer according to claim 46.

59. A method comprising:
(a) providing a fibrous and/or granular substrate;
(b) contacting the substrate with a formulation comprising a partially neutralized, carboxylate-rich copolymer according to claim 46; and
(c) binding the substrate.
